(19) United States
(12) Patent Application Publication
(10) Pub. No.: US 2010/0151252 A1
(43) Pub. Date: Jun. 17, 2010

(54) PROCESS FOR PRODUCING LIQUID CRYSTAL POLYMER LAMINATE

(75) Inventors: Yuji YAMAMOTO, Tokyo (JP); Yuriko KAIDA, Tokyo (JP); Takashi NAKANO, Tokyo (JP); Yoshitomi MORIZAWA, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: ASAHI GLASS COMPANY, LIMITED, Tokyo (JP)

(21) Appl. No.: 12/711,539

(22) Filed: Feb. 24, 2010

Related U.S. Application Data
(63) Continuation of application No. PCT/JP08/65337, filed on Aug. 27, 2008.

(30) Foreign Application Priority Data
Aug. 31, 2007 (JP) 2007-226311

(51) Int. Cl. B32B 9/04; B05D 5/06

(52) U.S. Cl. 428/411.1; 427/162

(57) ABSTRACT

To provide a process which is capable of producing, with good productivity, a liquid crystal polymer laminate having a uniformly aligned liquid crystal polymer and being excellent in transparency and which enables to enlarge the area.

A process for producing a liquid crystal polymer laminate comprising a substrate, a layer containing a liquid crystal polymer, and a layer containing a non-liquid crystal covering polymer, which comprises a step of forming the layer containing a liquid crystal polymer on the substrate surface, a step of forming the layer containing the covering polymer on the layer containing a liquid crystal polymer, a step of performing heat treatment at a temperature of at least the glass transition point or the melting point of the covering polymer and at most the clearing point of the liquid crystal polymer. The layer containing the covering polymer is preferably formed by applying a liquid containing the covering polymer and a solvent which does not substantially dissolve the liquid crystal polymer, on the layer containing the liquid crystal polymer, and removing the solvent.

### TECHNICAL FIELD

The present invention relates to a process for producing a liquid crystal polymer laminate.

### BACKGROUND ART

An optical film is required to be thin and have a large area.

As a process for producing an optically anisotropic film containing a liquid crystal substance as a constituting material, a process is known wherein a polymerizable liquid crystal composition is applied to a substrate and then polymerized. For the purpose of preventing unevenness in film thickness or alignment which is likely to result at the time of applying the polymerizable liquid crystal composition in this process, a method of adding a surfactant or a leveling agent to the polymerizable liquid crystal composition, is disclosed (Patent Documents 1 and 2).

However, conventional surfactants and leveling agents are poor in compatibility to the liquid crystal composition and may cause disorder in alignment. Further, when the polymerizable liquid crystal composition is applied to a substrate and left to stand at room temperature, crystals may sometimes precipitate. That is, there was a problem that a transparent film was not obtained.

On the other hand, a method is also known wherein a liquid crystal polymer obtained by preliminary polymerization is sandwiched between a pair of substrates provided with aligned films, followed by heat treatment to obtain an optical film (Patent Document 3). Further, it is known that a monoaxially aligned film can be obtained by forming a liquid crystal polymer into a film by a solution casting method, followed by heat treatment (Patent Document 4).

Patent Document 1: JP-A-8-231958

Patent Document 2: JP-A-11-148080

Patent Document 3: JP-A-4-16916

Patent Document 4: JP-A-2004-77719

### DISCLOSURE OF THE INVENTION

### Problems to be Solved by the Invention

In a case where a liquid crystal polymer is sandwiched between a pair of substrates provided with aligned films, the liquid crystal polymer may take a uniformly aligned state. However, in a case where a liquid crystal polymer is supported on a single substrate surface provided with an aligned film, such a liquid crystal polymer tends to hardly take a uniformly aligned state. Especially with a liquid crystal polymer on a free surface side, alignment of mesogen tends to be hardly constant, and as a result, a plurality of domains different in alignment direction used to be observed on the free surface side of a thin film of a liquid crystal polymer. Further, there was a problem such that a transparent film of a liquid crystal polymer was hardly obtainable by the formation of such a plurality of domains different in alignment direction.

It is an object of the present invention to provide a process which is capable of producing, with good productivity, a liquid crystal polymer laminate having a uniformly aligned liquid crystal polymer and being excellent in transparency and which enables to enlarge the area.

### Means to Solve the Problems

The present invention provides the following:

<1> A process for producing a liquid crystal polymer laminate comprising a substrate, a layer containing a liquid crystal polymer, and a layer containing a non-liquid crystal covering polymer, which comprises a step of forming the layer containing a liquid crystal polymer on the substrate surface, and a step of forming the layer containing the covering polymer on the layer containing a liquid crystal polymer, a step of performing heat treatment at a temperature of at least the glass transition point or the melting point of the covering polymer and at most the clearing point of the liquid crystal polymer.
<2> The process according to the above <1>, wherein the substrate surface is a surface with aligning treatments.
<3> The process according to the above <1> or <2>, wherein the step of forming the layer containing the covering polymer on the layer containing a liquid crystal polymer is a step of applying a liquid containing the covering polymer and a solvent which does not substantially dissolve the liquid crystal polymer, on the layer containing the liquid crystal polymer, and removing the solvent to form the layer containing the covering polymer.
<4> The process according to the above <3>, wherein the solvent which does not substantially dissolve the liquid crystal polymer is a fluorinated solvent.
<5> The process according to any one of the above <1> to <4>, wherein the covering polymer is a non-crystalline polymer.
<6> The process according to any one of the above <1> to <5>, wherein the covering polymer is a fluoropolymer.
<7> The process according to the above <6>, wherein the fluoropolymer is a polymer containing monomer units derived from a monomer represented by the following formula (1):

CH₂═CX—COO—(CH₂)₂—(CF₂)ₚ—F (1)

wherein the symbols are as follows:

X: a hydrogen atom, a chlorine atom or a methyl group,

p: 4, 5 or 6.

<8> The process according to any one of the above <1> to <5>, wherein the covering polymer is a silicone polymer.
<9> The process according to any one of the above <1> to <8>, wherein the liquid crystal polymer is a polymer containing monomer units derived from a monomer represented by the following formula (3):

CH₂═CR¹—COO—[(CH₂)ₘ—(CF₂)ᵣ—(CH₂)ₙ—O]ₜ-E¹-(G¹)ᵥ-(E²)ₕ-(G²)_{w}-(E³)ₖ-E⁴-R³ (3)

wherein the symbols are as follows:

R¹: a hydrogen atom or a methyl group,

R³: a C₁₋₈ alkyl group which may be fluorinated, a C₁₋₈ alkoxy group which may be fluorinated, or a fluorine atom,

E¹, E², E³, E⁴: each independently a 1,4-phenylene group or a trans-1,4-cyclohexylene group, provided that a hydrogen atom bonded to a carbon atom in such a group may be substituted by a

C₁₋₁₀ alkyl group, a C₁₋₁₀ alkoxy group or a fluorine atom,

G¹, G²: each independently —COO— or —OCO— (provided that the carbon atom in such an oxycarbonyl group is not bonded to the 1,4-phenylene group),

m: an integer of from 0 to 6,

r: an integer of from 0 to 6,

n: an integer of from 0 to 6,

provided that m+r+n is an integer of at least 1, and when r is 0, m+n is an integer of at most 10,

t: 0 or 1,

h: 0 or 1,

k: 0 or 1,

v: 0 or 1,

w: 0 or 1,

provided that v+w is 0 or 1.
<10> The process according to any one of the above <1> to <9>, wherein the aligned state of the liquid crystal polymer is a horizontal alignment to the substrate surface.
<11> A liquid crystal polymer laminate comprising a layer of a liquid crystal polymer formed on an aligned substrate surface, and a layer of a covering polymer formed on the layer of a liquid crystal polymer, wherein the liquid crystal polymer is formed as aligned at a temperature of at least the glass transition point or the melting point of the covering polymer and at most the clearing point of the liquid crystal polymer in such a state that the layer containing the liquid crystal polymer is present on the substrate surface.
<12> The liquid crystal polymer laminate according to the above <11>, wherein the layer containing the covering polymer is a layer formed by applying a liquid containing the covering polymer and a solvent which does not substantially dissolve the liquid crystal polymer, on the layer containing the liquid crystal polymer, and removing the solvent.

### EFFECT OF THE INVENTION

According to the process of the present invention, it is possible to produce a liquid crystal polymer laminate excellent in transparency with good productivity and to enlarge its area.

### BEST MODE FOR CARRYING OUT THE INVENTION

In this specification, a monomer represented by the formula (1) will be referred to as a monomer (1). Compounds represented by other formulae will be referred to in the same manner. Units (repeating units) derived from a monomer, in a polymer will be referred to as monomer units. Units derived from a monomer (1) will be referred to as monomer units (1), and other monomer units will be referred to in the same manner.

Terms used in this specification should be construed as follows.

“Liquid crystal polymer” means “polymer capable of showing a liquid crystal phase by itself”.

“Liquid crystal monomer” means a monomer which becomes a liquid crystal polymer by polymerization, and is a compound which may not necessarily have liquid crystallinity itself.

“Clearing point” means “nematic-to-isotropic phase transition temperature” and may be referred to also as Tc.

Symbol “Ph” represents a 1,4-phenylene group, and a hydrogen atom bonded to a carbon atom in such a group may be substituted by a C₁₋₁₀ alkyl group, a C₁₋₁₀ alkoxy group or a fluorine atom. Symbol “Cy” represents a trans-1,4-cyclohexylene group, and a hydrogen atom bonded to a carbon atom in such a group may be substituted by a C₁₋₁₀ alkyl group, a C₁₋₁₀ alkoxy group or a fluorine atom.

Symbol “Δn” is an abbreviation for “refractive index anisotropy”. Further, the value for wavelength in the following description may include a range of the disclosed value ±2 nm.

### Liquid Crystal Polymer Laminate

### Substrate

As the substrate in the present invention, ones having various shapes, made of organic materials or inorganic materials, may be used. Its shape may be any shape so long as it has a flat surface or a curved surface. It may, for example, be a plate or sheet having a flat surface, or a molded product having a curved surface as a constituting portion. An elongated sheet, film or the like may also be used. The substrate in the present invention may further have the following alignment film or an interlayer film.

The material constituting the substrate may be any material, whether it is an organic material or an inorganic material. An organic material useful as the material for the substrate may, for example, be a polyethylene terephthalate, a polycarbonate, a polyimide, a polyamide, a polymethyl methacrylate, a polystyrene, a polyvinyl chloride, a polytetrafluoroethylene, an ethylene/tetrafluoroethylene copolymer, a polychlorotrifluoroethylene, a polyarylate, a polysulfone, a triacetylcellulose, a cellulose, a polyether ether ketone, a polyethylene or a polypropylene. An inorganic material may, for example, be silicon, glass or calcite.

The substrate has an aligned surface, and on such a surface, a layer containing a liquid crystal polymer will be formed. The substrate having an aligned surface is preferably obtained by subjecting a substrate surface to alignment treatment. For example, it is possible to use a substrate treated by rubbing with e.g. fiber such as cotton, wool, nylon or polyester; a substrate having an organic thin film on its surface and treated by rubbing with e.g. a cloth; or a substrate having an alignment film formed by oblique vapor deposition of SiO₂. By preparing a substrate having such alignment treatment applied and disposing a liquid crystal polymer on the alignment-treated surface, the liquid crystal polymer in contact with the substrate surface will be in an aligned state.

In a case where it is not possible to obtain proper alignment by rubbing a substrate with e.g. fiber such as cotton, wool, nylon or polyester, it is advisable to form an organic thin film such as a polyimide thin film or a polyvinyl alcohol thin film on a substrate surface in accordance with a known method, and then rubbing such an organic thin film with e.g. a cloth.

It is also effective to provide an interlayer such as a polyimide thin film on a substrate in order to improve the coating or adhesion property of the liquid crystal polymer. In a case where adhesion between the liquid crystal polymer and the substrate is poor, the interlayer such as a polyimide thin film is effective also as a means to improve the adhesion.

### Liquid Crystal Polymer

As the liquid crystal polymer in the present invention, a known liquid crystal polymer may be used. It may be a main chain type liquid crystal polymer or a side chain type liquid crystal polymer. Particularly preferred is a side chain type liquid crystal polymer.

The liquid crystal polymer in the present invention preferably has a glass transition point (Tg). With a crystallizable polymer having no glass transition point, crystals are likely to precipitate, and a liquid crystal polymer laminate to be formed from such a liquid crystal polymer is likely to have its transparency deteriorated.

The clearing point (Tc) of the liquid crystal polymer in the present invention is preferably at least 80° C., particularly preferably at least 100° C. The upper limit is not particularly limited, but is preferably 250° C. Further, it is preferred that the liquid crystal polymer has a wide temperature range wherein it exhibits a smectic liquid crystal property. Also the temperature to exhibit the smectic liquid crystal property is preferably at least 80° C., particularly preferably at least 100° C. When the upper limit of the temperature range to show the clearing point (Tc) or the smectic liquid crystal property is the above mentioned temperature, the property change due to the temperature, of the liquid crystal polymer laminate to be formed from the liquid crystal polymer tends to be small.

The number average molecular weight of the liquid crystal polymer in the present invention is preferably from 3,000 to 50,000, more preferably from 5,000 to 30,000, further preferably from 5,000 to 20,000. If the molecular weight is too small, the crystallizability tends to appear, and a liquid crystal polymer laminate to be formed by using the liquid crystal polymer is likely to have its transparency deteriorated. If the molecular weight is too large, it tends to take time for the control of alignment, or the degree of alignment of liquid crystal tends to be low, and consequently, the transparency of the liquid crystal polymer laminate is likely to be low. The number average molecular weight is measured by a gel permeation chromatography method by using polystyrene as a standard substance.

The liquid crystal polymer in the present invention is preferably a side chain type liquid crystal polymer composed of a homopolymer or a copolymer obtainable by polymerizing at least one liquid crystal monomer. A side chain type liquid crystal monomer is obtainable by using a liquid crystal monomer which is a compound having a mesogen and a polymerizable group at its one end. The number of polymerizable groups in the liquid crystal monomer is preferably one. When such a liquid crystal monomer is copolymerized with a monomer having two or more polymerizable groups, the obtainable liquid crystal polymer becomes a polymer having a crosslinked structure, whereby the solvent solubility and thermoplasticity tend to deteriorate. Accordingly, the liquid crystal polymer in the present invention is preferably a liquid crystal polymer obtainable without substantially copolymerizing a monomer having two or more polymerizable groups.

The polymerizable group is preferably a polymerizable group (hereinafter referred to as a (meth)acryloyloxy group) selected from an acryloyloxy group and a methacryloyloxy group. Otherwise, it may, for example, be a vinyl group, a vinyloxy group, and allyl group, an allyloxy group, an isopropenyl group or an isopropenyloxy group.

The mesogen in the liquid crystal monomer preferably has a structure wherein at least two 6-membered rings are linearly connected. The connecting group to connect the 6-membered rings may, for example, be a single bond, —COO—, —OCO—, —C≡C— or —CH₂CH₂—. As the 6-membered ring, in addition to Ph and Cy, a pyridin-2,5-diyl group, a pyrimidin-2,5-diyl group, a 1,4-cyclohexenylene group or a trans-1,3-dioxan-2,5-diyl group may, for example, be mentioned. As the 6-membered ring, Ph and Cy are particularly preferred. The number of such 6-membered rings in the mesogen is preferably from 2 to 5, particularly preferably 3 or 4. In a case where two or more liquid crystal monomers are to be copolymerized, it is preferred to copolymerize two or more liquid crystal monomers each having three or four 6-membered rings in the mesogen, or to copolymerize a liquid crystal monomer having two 6-membered rings in the mesogen to a main component (exceeding 50% by molar ratio) of a liquid crystal monomer having three or four 6-membered rings in the mesogen. At the terminal having no polymerizable group, the mesogen may, for example, have an alkyl group, a halogen atom such as a fluorine atom, an alkoxy group or a cyano group. The alkyl group or the alkoxy group preferably has at most 20 carbon atoms, and some or all of its hydrogen atoms may be substituted by fluorine atoms.

The polymerizable group in the liquid crystal monomer is preferably a (meth)acryloyloxy group. The (meth)acryloyloxy group may be bonded directly to the 6-membered ring of the mesogen. Otherwise, it may be bonded to the 6-membered ring of the mesogen via a bivalent spacer. The bivalent spacer is preferably a bivalent organic group having hydrogen atoms of hydroxy groups removed from diol at one end (the (meth)acryloyloxy group-bonded side) and the other end (the mesogen-bonded side). As such a diol, an alkane diol, a polyfluoroalkane diol or a polyalkylene glycol is preferred. The number of its carbon atoms is preferably from 2 to 12, particularly preferably from 2 to 8. The polyalkylene glycol may be an oligomer of a C₂₋₆ alkylene glycol such as polyethylene glycol, polypropylene glycol or poly-1,4-butylene glycol.

As the liquid crystal monomer, a compound represented by the following formula (2) (hereinafter referred to as a monomer (2)) is preferred. The liquid crystal polymer in the present invention is preferably a polymer containing at least one type of monomer units derived from this monomer (2) i.e. monomer units (2). The proportion of monomer units (2) based on the total monomer units in the polymer is preferably from 60 to 100 mol %, more preferably from 80 to 100 mol %.

CH₂═CR¹—COO-(L-O)ₐ-A¹-(B¹)_{b}-(A²)_{c}-(B²)_{d}-(A³)ₑ-A⁴-R² (2)

The symbols in the formula are as follows.

R¹: a hydrogen atom or a methyl group.

R²: a C₁₋₈ alkyl group which may be fluorinated, a C₁₋₈ alkoxy group which may be fluorinated, a fluorine atom, a chlorine atom or a cyano group.

A¹, A², A³, A⁴: each independently a 1,4-phenylene group or a trans-1,4-cyclohexylene group, provided that a hydrogen atom bonded to a carbon atom in such a group may be substituted by a C₁₋₁₀ alkyl group, a C₁₋₁₀ alkoxy group or a fluorine atom.

B¹, B²: each independently —COO—, —OCO—, —C≡C—, —CH₂CH₂—, —(CH₂)₄—, —CH₂O—, —OCH₂—, —CH═CH— or —CF═CF—.

L: a C₂₋₈ alkylene group, a C₂₋₈ polyfluoroalkylene group or —(R⁴O)_{f}—R⁴— (wherein R⁴ is a C₂₋₄ alkylene group, and f is an integer of at least 1 and a number whereby the total number of carbon atoms in this group will be at most 12).

a to e: each independently 0 or 1.

The liquid crystal polymer in the present invention is further preferably one having a low absorption of blue laser light (wavelength: 300 to 450 nm). Specifically, it is preferred that when a tetrahydrofuran solution of the liquid crystal polymer (concentration: 10⁻⁵ mol/L) is put into a 1-cm-square cell and measured by an UV-VIS spectrometer, the absorbance at 300 nm is at most 0.1.

As liquid crystal polymers having high durability against blue laser light, liquid crystal polymers disclosed in the following literatures relating to the invention by the present inventors are known. As the liquid crystal polymers in the present invention, liquid crystal polymers having high durability against blue laser light as disclosed in such literatures are preferred. WO2006/001096, WO2006/001097, JP-A-2006-219524, JP-A-2006-219533, WO2007/046294 and JP-A-2007-169363.

According to a study by the present inventors, the liquid crystal monomer to obtain a liquid crystal polymer having high durability against blue laser light, is preferably a monomer which has a mesogen having from two to five 6-membered rings, wherein at least one of from two to five 6-membered rings is Ph, at least another one is Cy, and the connecting group to connect such 6-membered rings is a connecting group selected from a single bond, —COO—, —OCO—, —C≡C— and —CH₂CH₂—. Further, it is preferred that the mesogen does not have a carbonyl group directly bonded to Ph (i.e. the carbon atom of the oxycarbonyl group as a connecting group is not bonded to Ph), and does not have a cyano group directly bonded to Ph. A liquid crystal polymer obtainable from a monomer having a cyano group or a carbonyl group directly bonded to Ph (i.e. >C═O having a structure of -Ph-(C═O)O—), has low durability against blue laser light, and it is difficult to use such a liquid crystal polymer in an application wherein blue laser light is to be used. Preferred is a monomer which has a mesogen having three or four 6-membered rings, wherein among the three or four 6-membered rings, two or three are Ph, and one is Cy, and two or three connecting groups to connect the 6-membered rings are all single bonds, or one of them is —COO— or —OCO—, and the rest is a single bond.

The liquid crystal polymer having high durability against blue laser light is preferably a polymer containing at least one type of monomer units derived from a liquid crystal monomer represented by the following formula (3) (hereinafter referred to as a monomer (3)). The symbols R¹, R², E¹ to E⁴, m, r, n, h and k in the formula (3) are the same as defined above. The monomer (3) may not necessarily show a liquid crystal phase itself, so long as the polymerized polymer shows a liquid crystal phase. The proportion of the monomer units (3) based on the total monomer units in the polymer is preferably from 80 to 100 mol %, more preferably from 95 to 100 mol %. Most preferred is a liquid crystal polymer composed substantially solely of the monomer units (3).

CH₂═CR¹—COO—[(CH₂)ₘ—(CF₂)ᵣ—(CH₂)ₙ—O]ₜ-E¹-(G¹)ᵥ-(E²)ₕ-(G²)_{w}-(E³)ₖ-E⁴R³ (3)

In the monomer (3), R¹ is a hydrogen atom or a methyl group. It is preferred that R¹ is a hydrogen atom, since the glass transition point of a liquid crystal polymer obtainable by polymerizing the monomer (3) will be low, whereby the control of alignment will be easy.

The monomer (3) has, as R³, a C₁₋₈ alkyl group which may be fluorinated, a C₁₋₈ alkoxy group which may be fluorinated, or a fluorine atom, whereby the temperature range in which a liquid crystal polymer obtainable by copolymerizing the monomer (3) shows a liquid crystal phase, will be broad. When R³ is an alkyl group or an alkoxy group, the number of carbon atoms is preferably from 3 to 8, more preferably from 3 to 5, and when it has a straight chain structure, it is possible to broaden the temperature range wherein the liquid crystal polymer shows a liquid crystal phase.

Each of E¹, E², E³ and E⁴ which are independent of one another, is a 1,4-phenylene group or a trans-1,4-cyclohexylene group, provided that a hydrogen atom bonded to a carbon atom in such a group may be substituted by a C₁₋₁₀ alkyl group, a C₁₋₁₀ alkoxy group, or a fluorine atom. Especially the 1,4-phenylene group is preferably such that one or two hydrogen atoms bonded to carbon atoms in the group are substituted by methyl groups or fluorine atoms. When so substituted, the crystallizability of the liquid crystal polymer tends to be low, whereby it becomes easy to obtain a liquid crystal polymer laminate having a low haze.

Each of G¹ and G² is an oxycarbonyl group (—COO— or —OCO—), and it is necessary that the carbon atom of this oxycarbonyl group is not bonded to Ph, from the viewpoint of the durability against blue laser light. Accordingly, in a monomer (3) wherein an oxycarbonyl group is present, the carbon atom of the carbonyl group is bonded to Cy. A bond of an oxygen atom of this oxycarbonyl group may be bonded to Ph. When —COO— or —OCO— is present in the monomer (3), a bent portion may be formed in the mesogen structure, whereby the liquid crystal property may readily be obtainable.

Each of m, r and n which are independent of one another is an integer of from 0 to 6, provided that m+r+n is an integer of at least 1, and when r=0, m+n is an integer of at most 10, preferably an integer of from 2 to 6.

When r>0, r is preferably from 2 to 6, and m and n are from 1 to 3 and preferably an equal numerical value.

It is preferred that t is 1, since it is thereby possible to broaden the temperature range wherein the liquid crystal polymer shows a liquid crystal phase, and to facilitate the control of alignment. Although t may be 0, when this monomer is selected as one type of comonomers, the monomer units based on such a monomer are preferably at most 10 mol % in the total monomer units of the polymer.

Each of h and k which are independent of each other, is 0 or 1, and h+k is preferably 1 or 2. If the number of 6-membered rings becomes large, the liquid crystal polymer tends to hardly have a melting point, and an optically anisotropic film having a low haze is likely to be obtained. Accordingly, the number of 6-membered rings (h+k+2) is preferably 3 or 4.

Each of v and w which are independent of each other is 0 or 1, provided that v+w is 0 or 1. That is, each of v and w is 0, or one of them is 1 and the other is 0.

The following may be mentioned as preferred examples of the portion of —(CH₂)ₘ—(CF₂)ᵣ—(CH₂)ₙ— in the monomer (3):

—(CH₂)₂—, —(CH₂)₄—, —(CH₂)₆—, —CH₂—(CF₂)₂—CH₂—, —CH₂—(CF₂)₄—CH₂—, and —CH₂—(CF₂)₆—CH₂—.

The following may be mentioned as preferred examples of the portion of -E¹-(G¹)ᵥ-(E²)ₕ-(G²)_{w}-(E³)ₖ-E⁴- in the monomer (3): -Ph-Ph-, -Ph-Cy-, -Cy-Ph-, -Ph-Cy-Ph-, -Ph-Ph-Cy-, -Cy-Ph-Ph-, -Ph-Cy-Ph-Ph-, -Ph-OCO-Cy-, -Cy-COO-Cy-Ph-, -Cy-OCO-Cy-Ph-, -Ph-OCO-Cy-Ph-, -Ph-OCO-Cy-Cy-, -Ph-Cy-COO-Cy-Ph-, and -Ph-Cy-OCO-Cy-Ph-.

The following may be mentioned as preferred examples of —R³ in the monomer (3):

—C₃H₇, —C₄H₉, —C₅H₁₁, —C₆H₁₃, —C₇H₁₅, —C₈H₁₇, —OC₃H₇, —OC₄H₉, —OC₅H₁₁, —OC₆H₁₃, —OC₇H₁₅, and —OC₈H₁₇.

A more preferred monomer (3) is a compound having a total of three 6-membered rings i.e. E¹ and E⁴ being Ph, and one Cy, wherein t is 1, or a compound having a total of four 6-membered rings i.e. E¹, E⁴ and another one being Ph and one Cy, wherein t is 1. In such a compound, one Ph other than E⁴ has a methyl group or a fluorine atom, and R³ is an alkyl group having at most 6 carbon atoms. Such a compound does not have G¹ or G² (i.e. v+w=0).

The liquid crystal polymer in the present invention is preferably a polymer having at least two types of such monomer units (3). Such a liquid crystal polymer is capable of forming a liquid crystal polymer laminate which not only is excellent in the durability against blue laser light but has low crystallizability and high transparency, and the temperature range in which it shows a liquid crystal phase, is broad. A preferred number average molecular weight of such a liquid crystal polymer is the same as mentioned above.

At least two types of the monomer (3) are preferably two types different in the moiety of -E¹-(G¹)ᵥ-(E²)ₕ-(G²)_{w}-(E³)ₖ-E⁴-, more preferably two types different in the number of 6-membered rings. The liquid crystal polymer of the present invention is preferably a polymer obtainable by copolymerizing at least one type of the monomer (3) having three 6-membered rings (h or k is 0) and at least one type of the monomer (3) having four 6-membered rings (h and k are 1) as essential components, from such a viewpoint that the crystallizability is low, and the temperature range to show a liquid crystal phase is broad.

The liquid crystal polymer is obtained by polymerizing the liquid crystal monomer by a common polymerization method such as solution polymerization, suspension polymerization or emulsion polymerization. Solution polymerization is preferred, since the molecular weight can thereby be controlled. As a solvent to be used for the solution polymerization, dimethylformamide or toluene may, for example, be mentioned. In a case where solution polymerization is to be carried out, it is preferred to employ a thermal polymerization initiator, and an azo type initiator is more preferred. As the thermal polymerization initiator, one or more types may be used. The amount of the thermal polymerization initiator is preferably from 0.1 to 5 mass %, more preferably from 0.3 to 2 mass %, based on the total amount of the liquid crystal monomer. The obtained liquid crystal polymer may be used as it is or after carrying out e.g. purification, for forming a layer containing the liquid crystal polymer.

### Liquid Crystal Polymer Layer

A layer containing a liquid crystal polymer (hereinafter referred to as a liquid crystal polymer layer) may be composed solely of the above-described liquid crystal polymer, or may be composed of the above-described liquid crystal polymer containing additives (a chiral agent, a dichromatic dye, etc.) to provide the function as the liquid crystal polymer. Further, other components may be mixed to the liquid crystal polymer. As such other components, an ultraviolet absorber, an antioxidant, a photostabilizer, etc. may be mentioned. In a case where an ultraviolet absorber, an antioxidant, a photostabilizer, etc. are used as other components, the amount of such components is preferably at most 5 mass %, particularly preferably at most 2 mass %, based on the liquid crystal polymer.

The liquid crystal polymer layer is preferably formed by applying a solution of the liquid crystal polymer on a substrate surface and removing the solvent. Also in a case where a layer containing additives or other components is to be formed, it is preferred to employ a solution having them dissolved together with the liquid crystal polymer in a solvent. In the case of a liquid crystal polymer which becomes a melt having a low melting point and a low viscosity, it is also possible to form a liquid crystal polymer layer by applying the melt.

As the solvent, any solvent may be used so long as it is capable of dissolving the liquid crystal polymer, etc. For example, a solvent which is commonly used for dissolving a usual polymer may be used, such as a hydrocarbon solvent, an ether solvent, a chlorinated hydrocarbon solvent, an ester solvent, an alcohol solvent, a ketone solvent or an amide solvent. Specifically, toluene, tetrahydrofuran, methylene chloride or chloroform, may, for example, be mentioned. Such solvents may be used alone or in combination as a mixture of two or more of them and may suitably be selected in consideration of the vapor pressure and the solubility of the liquid crystal polymer. The concentration of the liquid crystal polymer in a solution having the liquid crystal polymer dissolved, is not particularly limited, but is preferably from 5 to 40 mass %. If the concentration is too high, it tends to be difficult to obtain a uniform layer, and if the concentration is too low, it tends to be difficult to obtain a layer having the desired thickness.

The thickness of the liquid crystal polymer layer to be formed is preferably from 0.1 to 20 μm, more preferably from 0.5 to 10 μm, further preferably from 1 to 7 μm. If it is thinner than 0.1 μm, the optical characteristics tends to be hardly obtainable, and if it exceeds 20 μm, alignment tends to be difficult, such being undesirable.

### Covering Polymer

The covering polymer in the present invention is non-liquid crystalline. If the covering polymer has liquid crystallinity, alignment irregularities tend to be formed in liquid crystal on the air interface side, whereby it tends to be difficult to obtain a transparent film. As the covering polymer, various polymers may be used so long as they satisfy the after-mentioned conditions of the glass transition point and melting point. The covering polymer may be amorphous or crystalline. The covering polymer is more preferably amorphous (one having no melting point), since a transparent laminate with the liquid crystal polymer can thereby be easily obtainable (since alignment of the liquid crystal polymer layer as an under layer is scarcely thereby disturbed), and the volume change is relatively small as between before and after the phase change of the covering polymer. Further, among such amorphous polymers, one having a less change in the linear expansion coefficient as between before and after the glass transition point, is preferred. Further, the covering polymer is preferably a linear polymer, but it may be a polymer having crosslinks.

The covering polymer layer is preferably formed by applying and drying a solution of a covering polymer. Accordingly, in such a case, the covering polymer is required to be solvent-soluble. A solvent-soluble polymer is usually a linear polymer, but a polymer having crosslinks may also be used so long as it is solvent-soluble. Further, formation of the covering polymer layer is not limited to the method of applying and drying a covering polymer solution. For example, in a case where the covering polymer is one which has a low melting point and which becomes a melt having a low viscosity, and the melt does not substantially dissolve the liquid crystal polymer, the covering polymer layer may be formed by applying the melt.

Further, it is also possible to form a covering polymer layer by applying and curing a curable resin on the liquid crystal polymer layer. The curable resin is a normal temperature-curable, thermosetting or photocurable compound or composition including a polymerizable oligomer or monomer. If such a curable resin is a liquid curable resin, it may be applied on the liquid crystal polymer layer without using any solvent and may be cured on the liquid crystal polymer layer. Even in the case of using a liquid curable resin, coating may be carried out by using a solvent. Further, a non-liquid curable resin may be applied as dissolved in a solvent. Curing of the curable resin is preferably carried out after forming a non-cured curable resin layer on the liquid crystal polymer layer and before carrying out the heat treatment in the present invention. In such a case, the curing temperature is lower than the heat treatment temperature. Otherwise, curing of the curable resin may be carried out at a temperature for the heat treatment in the present invention. In such a case, curing of the curable resin is considered to take place at a stage where the temperature is raised to the heat treatment temperature or in the earlier stage during the heat treatment.

The after-mentioned heat treatment is carried out at a temperature of at least the glass transition point (or at least the melting point) of the covering polymer and at most the clearing point (Tc) of the liquid crystal polymer. Therefore, if the glass transition point or melting point of the covering polymer is too high, the temperature range between it and the clearing point (Tc) of the liquid crystal polymer tends to be narrow, and it is likely that heat treatment tends to be difficult. Accordingly, the glass transition point or melting point of the covering polymer is preferably lower by at least 15° C., particularly preferably by at least 30° C., than the clearing point (Tc) of the liquid crystal polymer in the liquid crystal polymer layer. The glass transition point of the covering polymer may be at most room temperature. A more preferred combination of the liquid crystal polymer and the covering polymer is a combination of a liquid crystal polymer having a clearing point (Tc) of from 100 to 150° C. and a covering polymer having a glass transition point (or melting point) of at most 50° C., or a combination of a liquid crystal polymer having a clearing point (Tc) exceeding 150° C. and a covering polymer having a glass transition point (or melting point) of at most 120° C.

The solvent to be used for the solution of the covering polymer is preferably a solvent which does not substantially dissolve the liquid crystal polymer in the present invention. In a case where the curable resin is to be used as dissolved in a solvent, such a solvent is also preferably one which does not substantially dissolve the liquid crystal polymer. If the solvent is a solvent capable of dissolving the liquid crystal polymer, when the liquid containing the covering polymer is applied on the surface of the liquid crystal polymer layer, it is likely to dissolve the liquid crystal polymer and thus to disturb the surface of the liquid crystal polymer layer thereby to prevent alignment of the liquid crystal polymer during the heat treatment. Further, it may become difficult to form a uniform covering polymer layer. A similar problem may result also when the solvent to be used in combination with the curable resin is capable of dissolving the liquid crystal polymer. As the solvent which does not substantially dissolve the liquid crystal polymer, a fluorinated solvent is preferred. A similar problem may result also when the melt of the covering polymer itself or the liquid curable resin is capable of dissolving the liquid crystal polymer. Accordingly, in the case of forming a covering polymer layer by using the melt of the covering polymer itself or the liquid curable resin to form the covering polymer, without using any solvent, such a melt or liquid curable resin is preferably one which does not substantially dissolve the liquid crystal polymer.

In the present invention, the covering polymer may, for example, be preferably a (meth)acrylic polymer composed of a homopolymer or copolymer of a (meth)acrylate selected from an acrylate and a methacrylate, a vinyl ester polymer, a cycloolefin polymer, a silicone polymer, an ethylene/vinyl acetate copolymer, a styrene polymer, a polycarbonate, a fluorinated (meth)acrylate polymer obtained by polymerizing a monomer (hereinafter referred to as a fluorinated (meth)acrylate) selected from a fluorinated acrylate and a fluorinated methacrylate, a fluorinated cyclic polymer (such as Cytop, manufactured by Asahi Glass Company, Limited), a fluoroethylene/vinyl ether copolymer (such as Lumiflon, manufactured by Asahi Glass Company, Limited), or a tetrafluoroethylene/hexafluoropropylene/vinylidene fluoride copolymer. Particularly, a fluorinated polymer such as a fluorinated (meth)acrylate polymer, a fluorinated cyclic polymer or a fluoroethylene/vinyl ether copolymer, a silicone polymer, or a (meth)acrylic polymer, is preferred from such a viewpoint that it is a solvent which does not dissolve the liquid crystal polymer and which is soluble in a fluorinated solvent. Among them, preferred is a silicone polymer and a fluorinated polymer selected from a fluorinated (meth)acrylate polymer and a fluorinated cyclic polymer.

The above fluorinated (meth)acrylate polymer means a homopolymer or copolymer of a fluorinated (meth)acrylate, and the copolymer may be a copolymer of two or more fluorinated (meth)acrylates, or a copolymer of at least one fluorinated (meth)acrylate with another monomer. In the case of a copolymer with another monomer, the copolymerization ratio of such another monomer is preferably at most 80 mol %, particularly preferably at most 40 mol %. The fluorinated (meth)acrylate means an acrylate having fluorine atoms in an alcohol residue (provided that a hydrogen atom bonded to a carbon atom at the 2-position of the acryloyl group may be substituted by a chlorine atom), such as a polyfluoroalkyl acrylate or a fluoroalkyl acrylate, and a methacrylate having the same alcohol residue. The number of carbon atoms in the alcohol residue having fluorine atoms is preferably from 4 to 20, particularly preferably from 4 to 12. The alcohol residue preferably has at least two fluorine atoms, and the ratio of the number of fluorine atoms to the total of fluorine atoms and hydrogen atoms bonded to the carbon atoms in the alcohol residue is preferably at least 55%. Said another monomer may, for example, be a (meth)acrylate having no fluorine atom, a styrene monomer, a vinyl ether monomer, a vinyl ester monomer, or an olefin monomer. Further, as a crosslinkable monomer, a polyfunctional (meth)acrylate having at least two (meth)acryloyloxy groups, or a monomer having at least two polymerizable unsaturated groups such as a divinyl ether monomer, may be copolymerized in a small amount. The molecular weight of the fluorinated (meth)acrylate polymer is preferably from 3,000 to 100,000, but it is not limited thereto.

The above fluorinated cyclic polymer may, for example, be a polymer having cyclopolymerized monomer units of a cyclopolymerizable polyfluorodiene such as perfluorobutenyl vinyl ether or perfluoroallyl vinyl ether, or a polymer having monomer units derived from a polyfluorocyclic monomer (one having an unsaturated group on at least one of carbon atoms constituting the ring) such as perfluoro(2,2-dimethyl-1,3-dioxol) or perfluoro(2-methylene-1,3-dioxolane). Such a polymer may further have monomer units having no ring (such as tetrafluoroethylene units). The molecular weight of such a fluorinated cyclic polymer is preferably from 3,000 to 50,000, but it is not limited thereto.

The above fluorinated (meth)acrylate polymer and fluorinated cyclic polymer are easily soluble in a fluorinated solvent and can easily be laminated without bringing about repelling on a liquid crystal film. Further, such polymers have a low refractive index and thus have effects to prevent reflection of the laminate surface.

A particularly preferred fluorinated (meth)acrylate in the present invention is a compound represented by the following formula (1). That is, the above fluorinated polymer is particularly preferably a polymer containing monomer units derived from a monomer represented by the following formula (1). In the following formula (1), X is a hydrogen atom, a chlorine atom or a methyl group, and p is an integer of from 2 to 16. p is preferably 4, 5 or 6, particularly preferably 6. Such a preferred monomer (1) may be a mixture of a compound wherein p is 6 and a compound wherein p is other than 6.

CH₂═CX—COO—(CH₂)₂—(CF₂)ₚ—F (1)

The following may be mentioned as examples of the monomer (1):

CH₂═CH—COO—(CH₂)₂—(CF₂)₄—F

CH₂═CH—COO—(CH₂)₂—(CF₂)₆—F (1-1)

CH₂═CH—COO—(CH₂)₂—(CF₂)₈—F (1-4)

CH₂═CH—COO—(CH₂)₂—(CF₂)₁₀—F

CH₂═CH—COO—(CH₂)₂—(CF₂)₁₂—F

CH₂═C(CH₃)—COO—(CH₂)₂—(CF₂)₄—F

CH₂═C(CH₃)—COO—(CH₂)₂—(CF₂)₆—F (1-2)

CH₂═C(CH₃)—COO—(CH₂)₂—(CF₂)₈—F

CH₂═C(CH₃)—COO—(CH₂)₂—(CF₂)₁₀—F

CH₂═C(CH₃)—COO—(CH₂)₂—(CF₂)₁₂—F

CH₂═CCl—COO—(CH₂)₂—(CF₂)₄—F

CH₂═CCl—COO—(CH₂)₂—(CF₂)₆—F (1-3)

CH₂═CCl—COO—(CH₂)₂—(CF₂)₈—F

CH₂═CCl—COO—(CH₂)₂—(CF₂)₁₀—F

As a method for polymerizing a fluorinated (meth)acrylate such as the monomer (1), a common polymerization method may be employed, such as solution polymerization, suspension polymerization or emulsion polymerization. The solution polymerization is preferred, since the control of the molecular weight can thereby be carried out. As a solvent to be used for the solution polymerization, dimethylformamide or toluene may, for example, be mentioned. When the solution polymerization is to be carried out, it is preferred to employ a thermal polymerization initiator, and an azo type initiator is more preferred. Such thermal polymerization initiators may be used alone or in combination as a mixture of two or more of them. The amount of the thermal polymerization initiator is preferably from 0.1 to 5 mass %, more preferably from 0.3 to 2 mass %, based on the total amount of the monomer.

The silicone polymer is a polymer having a polydiorganosiloxane chain and is preferably a silicone polymer formed by curing a curable silicone. The polydiorganosiloxane chain is preferably a polydimethylsiloxane chain. The curable silicone is preferably a dimethylsiloxane oligomer having a curable group or a condensation curable silicone made of a polydimethylsiloxane. The curable group may, for example, be a silanol group, or a hydrolysable group (such as an alkoxy group, an acyl group or an oxime group) bonded to a silicon atom. Further, an addition curable silicone made of a combination of a silicone having an unsaturated group such as a vinyl group and a compound having hydrogen atoms bonded to a silicon atom, may also be used. Such a silicone is a liquid curable resin so-called a liquid silicone rubber. As the case requires, a curing agent or a curing accelerator may be blended thereto, followed by curing at room temperature or under heating to obtain a silicone polymer. The silicone polymer obtained from a liquid silicone rubber is a polymer having a rubbery property or an elastomer property, and its glass transition temperature (Tg) is at most room temperature, usually at most 0° C.

### Covering Polymer Layer

A layer containing the covering polymer (hereinafter referred to as a covering polymer layer) may be composed solely of the above covering polymer or may have components other than the covering polymer incorporated. As such other components, a plasticizer, an ultraviolet absorber, an antioxidant, a photostabilizer, a colorant, a filler, etc. may be mentioned. When such other components are to be used, the amount of such components is preferably at most 5 mass %, particularly preferably at most 2 mass %, based on the liquid crystal polymer.

The covering polymer layer is preferably formed by applying a solution of the covering polymer on the surface of the liquid crystal polymer layer and removing the solvent. Also in the case of forming a covering polymer layer containing other components, it is preferred that other components are dissolved in a solvent together with the covering polymer, but a component insoluble in the solvent may be present. This solvent is a solvent which does not substantially dissolve the above liquid crystal polymer, and “a solvent which does not substantially dissolve” means that the saturation concentration of the liquid crystal polymer is at most 0.01 g/L.

As mentioned above, formation of the covering polymer layer is not limited to the forming by the application and drying of a covering polymer solution. However, it is not easy to form a good covering polymer layer without using a solvent, and the type of the covering polymer applicable is also limited. Also in application of a liquid curable resin, it is preferred to use it as dissolved in a solvent, in a case where its viscosity is high. Accordingly, it is preferred to form a covering polymer layer by using a solvent, and such a case will be described below.

As the solvent which does not substantially dissolve the liquid crystal polymer, a fluorinated solvent is preferred, since the fluorinated solvent presents a high solubility to a fluoropolymer and presents a relatively low solubility to the liquid crystal polymer as compared with other solvents. The concentration of the covering polymer in the solution having the covering polymer dissolved therein, is not particularly limited, but is preferably from 1 to 30 mass %. If the concentration is too high, a uniform layer tends to be hardly obtainable, and if the concentration is too low, it tends to be difficult to obtain a layer having the desired thickness.

The fluorinated solvent is preferably a fluorinated solvent selected from the group consisting of a fluorocarbon solvent, a fluoroether solvent, a chlorofluorocarbon solvent, a hydrochlorofluorocarbon solvent and a fluorinated hydrocarbon alcohol solvent, which is liquid at 25° C. and has a boiling point of at least 40° C. The fluorinated solvent may be a mixture of two or more fluorinated solvents, or may be a mixed solvent of a fluorinated solvent with another solvent.

The fluorocarbon solvent is preferably a perfluorofluorocarbon solvent composed solely of fluorine atoms and carbon atoms, or a hydrofluorofluorocarbon solvent composed solely of hydrogen atoms, fluorine atoms and carbon atoms. Specific examples of the perfluorocarbon solvent include CF₃(CF₂)₄CF₃, CF₃(CF₂)₆CF₃, CF₃CF(CF₃)CF(CF₃)CF₂CF(CF₃)CF₂CF₃, perfluorocyclohexane, perfluorodecalin, perfluorobenzene, etc. Specific examples of the hydrofluorcarbon solvent include CF₃CHFCHFCF₂CF₃, CF₃(CF₂)₅H, CF₃(CF₂)₃CH₂CH₃, CF₃(CF₂)₅CH₂CH₃, CF₃(CF₂)₇CH₂CH₃, 1,3-bis(trifluoromethyl)benzene, etc.

The fluoroether solvent is preferably a perfluoroether solvent composed solely of an etheric oxygen atom, fluorine atoms and carbon atoms, or a hydrofluoroether solvent composed solely of an etheric oxygen atom, hydrogen atoms, fluorine atoms and carbon atoms. Specific examples of the perfluoroether solvent include perfluoro(2-butyltetrahydrofuran), etc. Specific examples of the hydrofluoroether solvent include CF₃CF₂CF₂CF₂OCH₃, (CF₃)₂CFCF(CF₃)CF₂OCH₃, CF₃CH₂OCF₂CHF₂, CHF₂CF₂OCH₃, etc.

The chlorofluorocarbon solvent is a solvent composed solely of chlorine atoms, fluorine atoms and carbon atoms. Specific examples include CCl₂FCClF₂, etc. The hydrochlorofluorocarbon solvent is a solvent composed solely of hydrogen atoms, chlorine atoms, fluorine atoms and carbon atoms, and specific examples include CCl₂FCH₃, CClF₂CF₂CHClF, CHCl₂CF₂CF₃, etc. The fluorinated hydrocarbon alcohol solvent is a solvent composed of a fluorinated hydrocarbon having an alcoholic hydroxy group, and specific examples include CHF₂CF₂CH₂OH, CF₃CF₂CF₂CFHCF₂CH₂OH, etc.

The thickness of the covering polymer layer to be formed is preferably from 0.05 to 10 μm, more preferably from 0.1 to 50 μm. If it is thinner than 0.05 μm, non-uniformity in film thickness tends to result, and it becomes difficult to obtain the optical property uniformly. If the thickness exceeds 100 μm, alignment of the liquid crystal polymer layer is likely to be non-uniform due to stress-strain of the covering polymer layer.

### Process for Producing Liquid Crystal Polymer Laminate

The process of the present invention comprises the following steps. The following steps 1, 2 and 3 are carried out in this order, but other steps may be included between the respective steps.

Step 1: A step of forming a layer containing a liquid crystal polymer on a substrate surface.

Step 2: A step of forming a layer containing a covering polymer on the layer containing a liquid crystal polymer.

Step 3: A step of performing heat treatment at a temperature of at least the glass transition point or the melting point of the covering polymer and at most the clearing point (Tc) of the liquid crystal polymer.

Step 1 is a step of forming the above-mentioned liquid crystal polymer layer. It is preferred that a solution of the liquid crystal polymer is applied on a substrate surface to form a thin film of the solution, and then, the solvent is removed to form a liquid crystal polymer layer. For example, a method may be mentioned wherein the liquid crystal polymer solution is applied on the surface of a substrate having alignment treatment applied, by e.g. spin coating, followed by heating to evaporate and remove the solvent. Step 2 is a step of forming the above covering polymer layer. It is preferred that a liquid containing a covering polymer and a solvent which does not substantially dissolve the liquid crystal polymer is applied on the liquid crystal polymer layer, and the solvent is removed to form the covering polymer layer. For example, a method may be mentioned wherein the covering polymer solution is applied to the surface of the liquid crystal polymer layer by a method such as spin coating, followed by heating to evaporate and remove the solvent.

By the above spin coating method, it is possible to control the film thickness by the rotational speed of spin coating or by the concentration of the solution of the liquid crystal polymer or the covering polymer. As the coating method in step 1 or 2, it is possible to employ not only spin coating but also die coating, extrusion coating, roll coating, wire bar coating, gravure coating, spray coating, dipping or printing. As a method for evaporating and removing the solvent, natural drying, heat drying, vacuum drying, vacuum-and-heat drying may be employed.

The heat treatment in step 3 is carried out at a temperature of at least the glass transition point (or at least the melting point) of the covering polymer and at most the clearing point (Tc) of the liquid crystal polymer. By this heat treatment, the entire liquid crystal polymer can be aligned. If the temperature is lower than the glass transition point (or lower than the melting point) of the covering polymer, alignment of the liquid crystal tends to be hardly uniform. If the temperature is higher than the clearing point (Tc) of the liquid crystal polymer, the liquid crystal tend to be random, whereby fixing in an aligned state tends to be difficult. As the heat treatment temperature is higher, it becomes possible to align the liquid crystal polymer in a shorter time. Accordingly, the heat treatment temperature is preferably close to the clearing point (Tc). However, if it is too close, the temperature control tends be difficult. Therefore, it is preferred to carry out the heat treatment at a temperature within a temperature range of (Tc-2)° C. to (Tc-50)° C. under such a condition that it is at least the glass transition point (or at least the melting point) of the covering polymer. More preferably, the heat treatment is carried out at a temperature within a temperature range of from (Tc-5)° C. to (Tc-20)° C. The heat treatment time is shorter as the temperature is higher. In a case where the heat treatment is carried out at a temperature of at least 80° C., it is preferred to maintain the above heat treatment temperature for usually from 0.5 minute to one hour, particularly preferably from one minute to 30 minutes.

After completion of the heat treatment, annealing is carried out to obtain the desired laminate. Even by quenching, the desired laminate may be obtained, but in order to obtain a highly transparent film, the cooling rate is preferably low not to disturb the alignment of the aligned liquid crystal polymer. The cooling rate is not particularly limited, but it is preferably at most 10° C./min.

By the process of the present invention, three dimensional alignment control of the liquid crystal polymer is possible. The three dimensional alignment of liquid crystal thus obtainable may, for example, be horizontal alignment or hybrid alignment. When the liquid crystal polymer is supported on one sheet of a substrate provided with an alignment film, one having a high contact angle is likely to have hybrid alignment, and one having a low contact angle is likely to have horizontal alignment. Accordingly, in a case where fluorine atoms are contained in a large amount in the liquid crystal polymer, alignment after the control is likely to be hybrid alignment, and in a case where fluorine atoms are contained in a small amount, the alignment is likely to be horizontal alignment. In the present invention, horizontal alignment is preferred for such a reason that its application range is wide.

The liquid crystal polymer laminate obtained by the above process has a three layered structure of substrate (layer)/liquid crystal polymer layer/covering polymer layer. The liquid crystal polymer laminate obtainable by the present invention may have such a three layered structure, or may have a two layered structure of liquid crystal polymer layer/covering polymer layer obtained by removing the substrate later. Further, it is also possible to obtain a film of the liquid crystal polymer by removing the substrate and the covering polymer layer from the liquid crystal polymer laminate. Further, a covering polymer layer may be formed anew on the liquid crystal polymer layer surface of the double layer structure of liquid crystal polymer layer/covering polymer layer to obtain a three layered structure of covering polymer layer/liquid crystal polymer layer/covering polymer layer.

Further, the present invention provides a liquid crystal polymer laminate comprising a liquid crystal polymer layer and a covering polymer layer, as described above. That is, the present invention further provides the following liquid crystal polymer laminate.

A liquid crystal polymer laminate comprising a layer containing a liquid crystal polymer and a layer containing a covering polymer, which comprises a layer containing a liquid crystal polymer formed on an aligned substrate surface, and a layer containing a covering polymer formed on the layer containing a liquid crystal polymer, wherein the liquid crystal polymer is aligned at a temperature of at least the glass transition point or the melting point of the covering polymer and at most the clearing point of the liquid crystal polymer in such a state that the layer containing the liquid crystal polymer is present on the substrate surface.

As described above, the covering polymer layer in the above laminate is preferably a layer formed by applying a liquid containing a covering polymer and a solvent which does not substantially dissolve the liquid crystal polymer, on the layer containing the above liquid crystal polymer, and removing the solvent.

Further, in the present invention, between the substrate and the liquid crystal polymer layer or on the covering polymer layer, another layer which presents no adverse effects to both layers, may be formed. Such another layer may, for example, be a layer to improve the adhesion, a layer for reinforcement, a hard coat layer, an ultraviolet absorber layer, an antireflection layer, various filter layers or the like.

The liquid crystal polymer laminate of the present invention has the substrate as a support, and it may be used, as supported on the support, as an optically anisotropic film or it may be peeled from the substrate and used as an optically anisotropic film free from the substrate. Further, the liquid crystal polymer laminate of the present invention may be used as laminated on another thin film or substrate. The liquid crystal polymer layer in the liquid crystal polymer laminate of the present invention is optically transparent and has anisotropy as an optically anisotropic film and thus is useful for an application where the function to modulate polarized light is utilized. Specifically, it is useful for an application where the phase state or wavefront state of polarized light is modulated, and it is suitably applied to an optical element having an optically anisotropic film. For example, an optical element having an optically anisotropic film of the present invention is useful as e.g. a waveplate as mounted on a liquid crystal display or optical pickup device.

Further, the covering polymer layer not only has a function to align the liquid crystal polymer as mentioned above, but also has a function to stabilize the alignment of the liquid crystal polymer. Further, other functions may be imparted to the covering polymer layer. For example, in a case where it is made of a polymer having a low refractive index composed of a fluoropolymer having a high fluorine content, it may exhibit an antireflection function, and in a case where it is made of a polymer having a relatively high mechanical strength or chemical stability as compared with the liquid crystal polymer, it may exhibit a function to protect the surface.

For a liquid crystal cell to be used for a liquid crystal display, various alignment systems such as TN, STN, ECB, VA, IPS and OCB have been proposed. In any system, in order to obtain sufficient image qualities (contrast, color purity, viewing angle characteristics, response speed) as a display, in addition to the liquid crystal cell, an overall optical design together with other optical components, is required. The polarized state of light emitted from a liquid crystal cell may not necessarily be optically preferred depending upon the viewing angle, and for the purpose of compensating it, a waveplate having a refractive index anisotropy may be used. The waveplate is classified based on the three dimensional refractive index structure i.e. the refractive index ellipsoidal shape, and a positive A plate, a negative A plate, a positive C plate or a negative C plate may, for example, be mentioned. Further, a twist retardation film, a viewing angle enlarging film or a temperature compensation film, may, for example, be mentioned.

A waveplate having a retardation value controlled, may be mentioned as an example wherein it is used as mounted on an optical pickup device. A quarter-waveplate having the retardation value controlled to be ¼ of the wavelength, or a half-waveplate having the retardation value controlled to be ½ of the wavelength, may be mentioned. The waveplate is an element capable of changing an incident polarized light. That is, the half-waveplate may be used as an element to switch p-polarized light and s-polarized light, and the quarter-waveplate may be used as an element to switch linear polarized light and circular polarized light. By using an element to change the polarized light, the incident light utilization efficiency (transmittance), information-reading accuracy, etc. can be improved.

A film taking such an aligned state functions as a retardation film. That is, a horizontal alignment film may be used as a positive A plate or a waveplate (¼ or ½), a vertical alignment film as a positive C plate, a twist alignment film as a twist retardation film, and a hybrid alignment film as a viewing angle enlarging film. Further, in addition to such application, it may function also as a temperature compensation film depending upon the temperature characteristics.

### EXAMPLES

Now, the present invention will be described with reference to Examples (Examples 1 to 7, 9, 10, 12 and 18 to 21) and Comparative Examples (Examples 8, 11 and 13 to 17), but it should be understood that the present invention is by no means thereby restricted.

### Molecular Weight

A number average molecular weight as calculated as polystyrene, was obtained by using GPC (product name: HLC-8220, manufactured by Tosoh Corporation). Measurements of Melting Point, Glass Transition Point and Phase Transition

### Temperature

A peak temperature was identified by using DSC (product name: DSC3100S, manufactured by Bruker AXS). The temperature raising condition was 10° C./min. Further, identification of the liquid crystal phase and crystal was carried out by observation by using a polarization microscope (product name: BX-51, manufactured by Olympus Corporation).

### In-Plane Irregularity

The in-plane irregularity of a sample was observed by a pair of polarizing plates arranged in a cross Nicol state. That is, on a light box, the polarizing plates were set in a cross Nicol state, and a sample was rotated and inclined as it was sandwiched between the polarizing plates, whereby the alignment irregularity of the sample was observed.

### Aligned State

The aligned state was measured and analyzed by a rotating analyzer method by using an optical material inspection apparatus (product name: RETS-100, manufactured by Otsuka Electronics Co., Ltd.).

### Haze

The haze was measured by using a haze meter (product name: HGM-3K, manufactured by Suga Test Instruments Co., Ltd.).

Monomers used for the polymerization of liquid crystal polymers are shown below.

The following monomer (3-2) and monomer (X) are known compounds, and the preparation method for monomer (3-2) is disclosed in Preparation Example 6 in the above-mentioned WO2007-046294. The preparation methods for the following monomer (3-1) and monomer (3-3) are shown below.

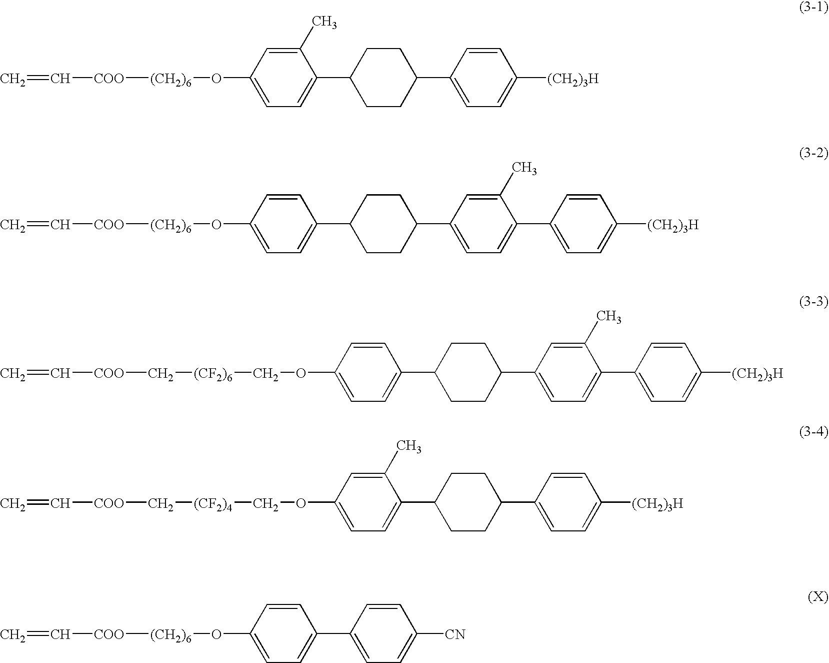

### Preparation Example 1

### Preparation of Monomer (3-1) to be Used in Examples

Monomer (3-1) was prepared by the following preparation route. The details of the preparation will be described as follows.

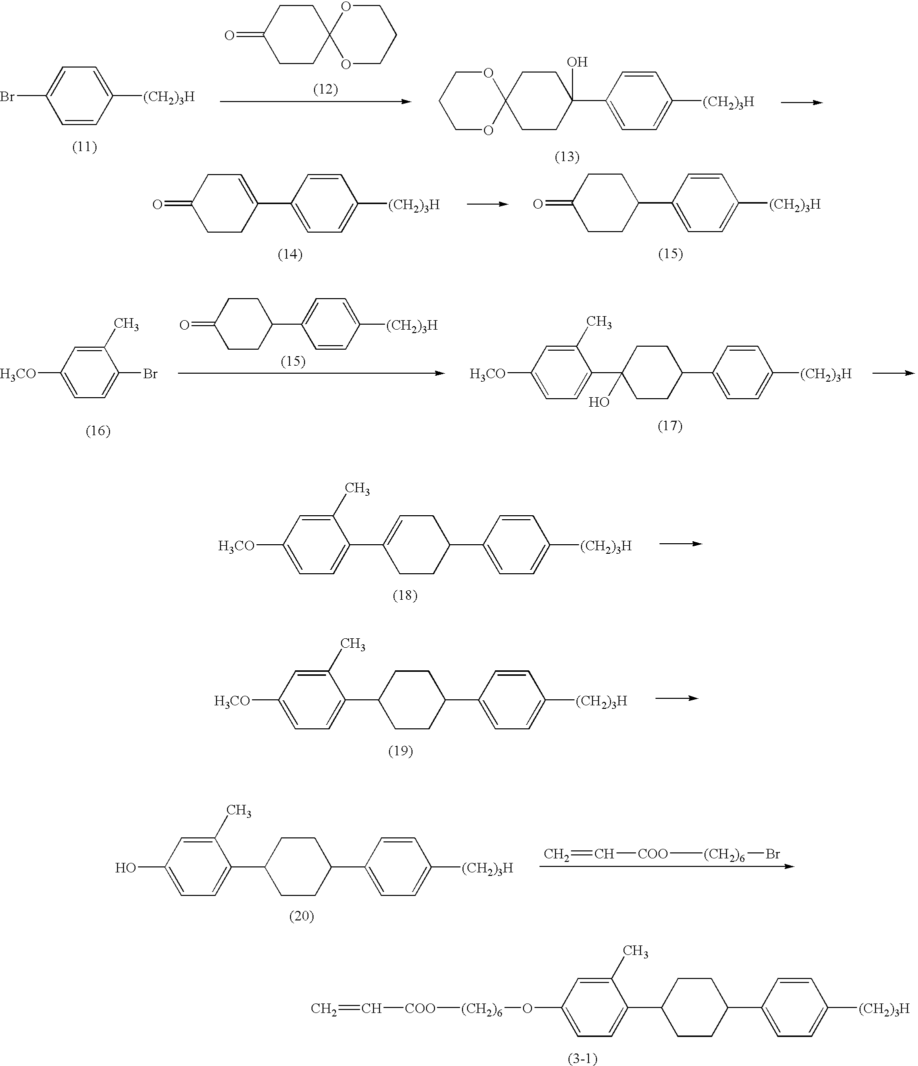

### Preparation of Compound (13):

Into a 1 L four-necked flask equipped with a reflux device and a dropping device, magnesium (6.45 g) was added, and one having 4-propylbromobenzene (compound (11), 50 g) dissolved in dehydrated tetrahydrofuran (200 mL) was dropwise added over a period of 60 minutes in a nitrogen stream. After completion of the dropwise addition, 100 mL of dehydrated tetrahydrofuran was further dropwise added, followed by stirring for two hours to prepare a Grignard reagent. Then, this four-necked flask was cooled to 0° C., one having 1,1′-bicyclohexane-1,4-dione monoethylene ketal (compound (12), 35.1 g) dissolved in dehydrated tetrahydrofuran (200 mL) was dropwise added over a period of 60 minutes in a nitrogen stream. After completion of the dropwise addition, stirring was carried out for two hours at room temperature, and then, an ammonium chloride aqueous solution was added to terminate the reaction.

Then, water and diethyl ether were added for liquid separation, whereupon the organic layer was recovered. The recovered organic layer was washed with a saturated sodium chloride aqueous solution (40 mL) and then with water, whereupon the organic layer was recovered again. The organic layer was dried over anhydrous magnesium sulfate, and then, the anhydrous magnesium sulfate was removed by filtration under reduced pressure, whereupon the filtrate was concentrated. The obtained solid was purified by column chromatography using hexane/dichloromethane (5:5, volume ratio) as a developing liquid, to obtain 42.4 g of compound (13). The yield was 68.3%.

### Preparation of Compound (14):

Into a 500 mL four-necked flask equipped with a reflux device and a stirrer, compound (13) (40 g) and 50 mL of trifluoroacetic acid were added and stirred at room temperature for one hour. After completion of the reaction, 50 mL of a saturated sodium hydrogen carbonate aqueous solution was added to terminate the reaction. Then, water and diethyl ether were added for liquid separation, and the organic layer was recovered. The recovered organic layer was washed with a saturated sodium chloride aqueous solution (40 mL) and then with water, whereupon the organic layer was recovered again. The organic layer was dried over anhydrous magnesium sulfate, and then, the anhydrous magnesium sulfate was removed by filtration under reduced pressure, whereupon the filtrate was concentrated. The reaction solution was poured into a flask and extracted with diethyl ether. The organic layer was washed with a saturated sodium chloride aqueous solution and dried over magnesium sulfate, and then, the solvent was distilled off. The obtained solid was purified by column chromatography using ethyl acetate/hexane (7:3, volume ratio) as a developing liquid, to obtain 26.3 g of compound (14). The yield was 84.1%.

### Preparation of Compound (15):

Into a 500 mL pressure resistant container, compound (14) (25 g), 10% palladium-activated carbon (3 g) and dehydrated hydrofuran (300 mL) were added, and then, hydrogen was filled at 0.4 Mpa. While the internal pressure was maintained at 0.4 Mpa, stirring was continued for 8 hours at room temperature until a pressure drop was no longer observed. After completion of the reaction, the 10% palladium activated carbon was filtered off, and the filtrate was concentrated. The obtained solid was purified by column chromatography using ethyl acetate/hexane (7:3, volume ratio) as a developing liquid to obtain 22.7 g of compound (15). The yield was 89.9%.

### Preparation of Compound (17):

Into a 500 mL four-necked flask equipped with a reflux device, a stirrer and a dropping device, magnesium (1.53 g) was added, and one having compound (15) (19.3 g) dissolved in dehydrated tetrahydrofuran (50 mL) was dropwise added over a period of 30 minutes in a nitrogen stream. After completion of the dropwise addition, stirring was carried out for 3 hours at 70° C. under reflux to prepare a Grignard reagent. Then, this four-necked flask was cooled to 0° C., and one having compound (16) (17.1 g) dissolved in dehydrated tetrahydrofuran (100 mL) was dropwise added over a period of 30 minutes in a nitrogen stream. After completion of the dropwise addition, stirring was carried out for 3 hours at 70° C. under reflux, and then a 1 mol/L ammonium chloride aqueous solution (100 mL) was added to terminate the reaction. Then, water and diethyl ether were added for liquid separation, and the organic layer was recovered. The recovered organic layer was washed with a saturated sodium chloride aqueous solution (40 mL) and then with water, whereupon the organic layer was recovered again. The organic layer was dried over anhydrous magnesium sulfate, and then, the anhydrous magnesium sulfate was removed by filtration under reduced pressure, whereupon the filtrate was concentrated. The obtained filtrate was purified by column chromatography using ethyl acetate/hexane (7:3, volume ratio) as a developing liquid, to obtain 20.7 g of compound (17). The yield was 68%.

### Preparation of Compound (18):

Into a 500 mL eggplant-type flask equipped with a reflux device and a stirrer, compound (24) (20.3 g), p-toluene sulfonic acid monohydrate (0.65 g) and toluene (400 mL) were added, and an isobaric dropping funnel containing a molecular sieve 4A (50 g) was attached thereto, and stirring was carried out for 4 hours at 110° C. under reflux. After completion of the reaction, water and diethyl ether were added for liquid separation, and the organic layer was recovered. The recovered organic layer was washed with a saturated sodium chloride aqueous solution (40 mL) and then with water, whereupon the organic layer was recovered again. The organic layer was dried over anhydrous magnesium sulfate, and then, the anhydrous magnesium sulfate was removed by filtration under reduced pressure, whereupon the filtrate was concentrated to obtain 14.9 g of compound (18). The yield was 71%.

### Preparation of Compound (19):

A 5 L pressure resistant reactor equipped with a stirrer was sufficiently deaerated, and compound (18) (12.4 g), tetrahydrofuran (200 mL) and 10% palladium activated carbon (2.5 g) were added under reduced pressure. Then, hydrogen was added to 0.4 MPa, followed by stirring for about two hours at a low temperature. Excess hydrogen was purged and then, the solid was removed by filtration, whereupon the filtrate was washed with 100 mL of diethyl ether. It was then concentrated by an evaporator to obtain a cis-trans mixture (11.6 g) of compound (19). The yield was 95%.

Hexane (100 mL) was added thereto, followed by recrystallization to obtain a trans-isomer (2.00 g) of compound (19). Further, one having the filtrate concentrated was transferred to a 500 mL eggplant-type flask, and t-butoxy potassium (28.0 g) and N,N-dimethylformamide (300 mL) were added, followed by stirring at 100° C. for 6 hours under reflux to convert the cis-isomer of compound (19) to a trans-isomer. After completion of the reaction, water (500 mL) was added to terminate the reaction, and diethyl ether was added for liquid separation, whereupon the organic layer was recovered. The recovered organic layer was washed with a saturated sodium chloride aqueous solution (40 mL) and then with water, whereupon the organic layer was recovered again. The organic layer was dried over anhydrous magnesium sulfate, and then, the anhydrous magnesium sulfate was removed by filtration under reduced pressure. The filtrate was concentrated and then, hexane (100 mL) was added, followed by recrystallization to obtain a trans-isomer (2.07 g) of compound (19). The total yield of compound (26) being a trans-isomer was 4.07 g, and the yield was 32%.

### Preparation of Compound (20):

Into a 500 mL four-necked flask equipped with a reflux device, a stirrer and a dropping device, compound (19) (3.75 g) and dichloromethane (200 mL) were added. In a nitrogen stream, boron tribromide (12.74 g) was dropwise added over a period of 30 minutes. The dropwise addition was carried out while cooling with ice so that the internal temperature would not exceed 10° C. After continuing stirring at room temperature for 3 hours, water was added to terminate the reaction. Diethyl ether was added for liquid separation, and the organic layer was recovered. The recovered organic layer was washed with a saturated sodium chloride aqueous solution (40 mL) and then with water, whereupon the organic layer was recovered again. The organic layer was dried over anhydrous magnesium sulfate, and then, the anhydrous magnesium sulfate was removed by filtration under reduced pressure, and the filtrate was concentrated, followed by recrystallization by using a mixed solvent (100 mL) of dichloromethane and hexane to obtain compound (20) (3.53 g). The yield was 95%.

### Preparation of Monomer (3-1):

A mixture comprising compound (20) (5.25 g), CH₂═CH—COO—(CH₂)₆—Br (3.37 g), potassium carbonate (4.22 g), potassium iodide (0.409 g) and dehydrated acetone (200 mL), was refluxed under heating for 24 hours. Diethyl ether (100 mL) and water (200 mL) were added for liquid separation, and the organic layer was recovered. The organic layer was washed with 1 M hydrochloric acid (100 mL) and then with a saturated sodium chloride aqueous solution (200 mL), whereupon the organic layer was recovered again. The organic layer was dried over anhydrous magnesium sulfate, and then, the anhydrous magnesium sulfate was removed by filtration under reduced pressure. The solvent was distilled off under reduced pressure, and the obtained residue was purified by column chromatography (developer: dichloromethane/hexane=5/5, volume ratio) to obtain a fraction containing the desired product. This fraction was concentrated to obtain powdery crystals. To the powdery crystals, hexane (100 mL) was added, followed by recrystallization to obtain monomer (3-1) (5.81 g). The yield was 74%.

### Spectrum Data of Monomer (3-1):

¹H-NMR (300.4 MHz, solvent: CDCl₃, standard: TMS) δ (ppm): 0.95 (t, 3H), 1.46-2.06 (m, 18H), 2.33 (s, 3H), 2.54-2.59 (m, 4H), 3.91-3.95 (t, 2H), 4.14-4.19 (t, 2H), 5.79-5.83 (dd, 1H), 6.08-6.17 (dd, 1H), 6.37-6.43 (dd, 1H), 6.70-6.73 (d, 2H), 7.11-7.26 (m, 9H)

### Preparation Example 2

### Preparation of Monomer (3-3) to be Used in Examples

Monomer (3-3) was prepared by the following preparation route. The details of the preparation will be described as follows.

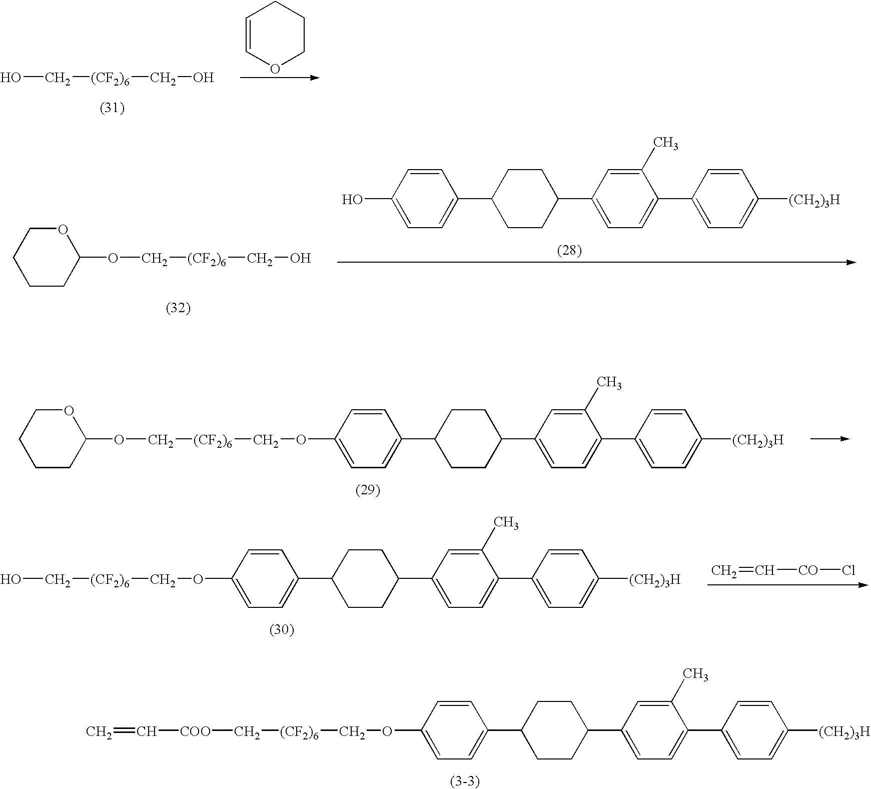

### Preparation of Compound (32):

Into a 5 L four-necked flask equipped with a reflux device and a stirrer, compound (31) (50.0 g) and 3,4-dihydrofuran (7.0 mL) were added and reacted at room temperature in the presence of p-toluene sulfonic acid (0.54 g) in dichloromethane (3,500 mL), to obtain 20.68 g of compound (32).

### Preparation of Compound (29):

Into a 1 L four-necked flask equipped with a reflux device and a stirrer, compound (32) (24.87 g), diethyl ether (500 mL) and triethylamine (14 mL) were added. After cooling to 0° C., 1,1,2,2,3,3,4,4,4-nonafluorobutane sulfonyl fluoride (12.31 mL) was added, and the temperature was gradually raised to room temperature, followed by stirring for 40 hours. Water (300 mL) was added, and the organic layer was washed with a saturated sodium chloride aqueous solution and dried, and then the solvent was removed to obtain a crude product (52.1 g) of 2,2,3,3,4,4,5,5,6,6,7,7-dodecafluoro-8-(tetrahydro-2H-pyran-2-yloxy)octyl-1,1,2,2,3,3,4,4,4-nonafluorobutane sulfonate.

This crude product (36.99 g) and compound (28) (13.86 g) were dissolved in N,N-dimethylformamide (300 mL), and cesium carbonate (42.78 g) was added thereto, followed by stirring at 80° C. for 0.5 hour. Water (400 mL) was added thereto, and the mixture was extracted with t-butyl methyl ether (250 mL×3 times). The obtained organic layer was washed with a saturated sodium chloride aqueous solution (250 mL), and then, the solvent was removed to obtain a crude product of compound (29). This crude product was purified by column chromatography using hexane/ethyl acetate (15:1, volume ratio) as a developing liquid, to obtain 25.38 g of compound (29). The yield was 61.5%.

### Preparation of Compound (30):

Into a 1 L four-necked flask equipped with a reflux device and a stirrer, compound (29) (25.37 g), methanol (400 mL), tetrahydrofuran (50 mL) and p-toluene sulfonic acid monohydrate (0.71 g) were added and stirred at room temperature for 3 hours. Triethylamine (4.09 mL) was added, and the solvent was distilled off under reduced pressure to obtain a crude product. This crude product was purified by column chromatography using hexane/ethyl acetate (6:1, volume ratio) as a developing liquid to obtain 19.50 g of compound (30). The yield was 93%.

### Preparation of Monomer (3-3):

Into a 1 L four-necked flask equipped with a reflux device and a stirrer, compound (30) (19.50 g), dichloromethane (500 mL) and triethylamine (6 mL) were added and cooled to 0° C. Acrylic acid chloride (3.40 mL) was added, and the temperature was gradually raised to room temperature, followed by stirring for 14 hours. The solvent was distilled off under reduced pressure, and the obtained crude product was purified by column chromatography using hexane/ethyl acetate (10:1, volume ratio) as a developing liquid, to obtain 16.96 g of monomer (3-3). The yield was 84%.

### Spectrum Data of Monomer (3-3):

¹H-NMR (300.4 MHz, solvent: CDCl₃, standard: TMS) δ (ppm): 0.99 (t, 3H), 1.53-2.05 (m, 10H), 2.29 (s, 3H), 2.63 (m, 4H), 4.45 (t, 2H), 4.67 (t, 2H), 5.98 (dd, 1H), 6.18 (dd, 1H), 6.53 (dd, 1H), 6.91 (m, 2H), 7.11-7.23 (m, 9H)

¹⁹F-NMR (282.7 MHz, solvent: CDCl₃, standard: TMS) δ (ppm): −120.0 (m, 4F), −122.5 (m, 4F), −123.7 (m, 2F), −123.9 (m, 2F)

### Preparation Example 3

### Preparation of Monomer (3-4) to be Used in Examples

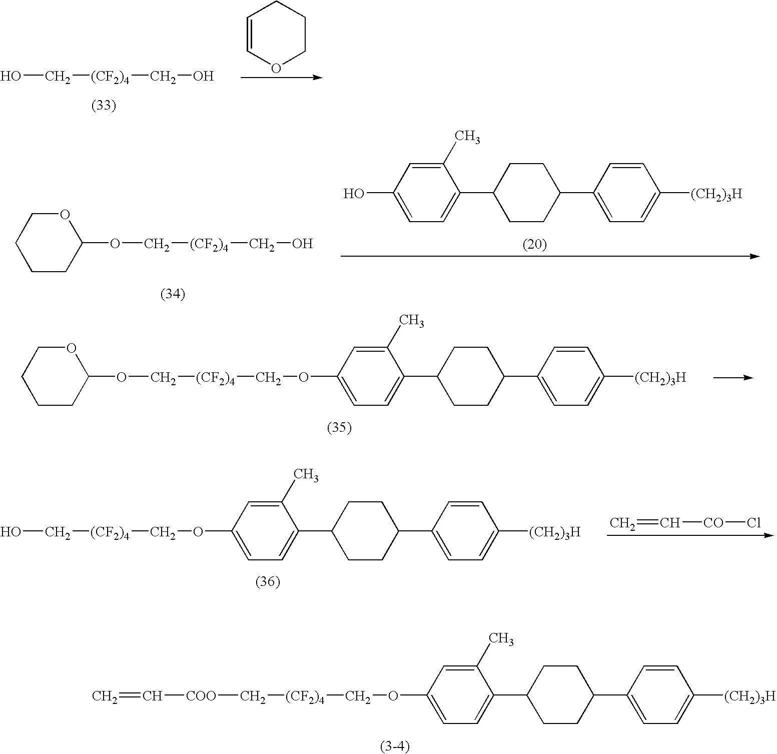

### Preparation of Compound (34):

Into a 5 L four-necked flask equipped with a reflux device and a stirrer, compound (33) (50.0 g) and 3,4-dihydropyran (9.6 mL) were added and reacted at room temperature in the presence of p-toluene sulfonic acid (0.74 g) in dichloromethane (500 mL) to obtain 24.90 g of compound (34).

### Preparation of Compound (35):

Into a 1 L four-necked flask equipped with a reflux device and a stirrer, compound (34) (24.90 g), diethyl ether (500 mL) and triethylamine (14.3 mL) were added. After cooling to 0° C., 1,1,2,2,3,3,4,4,4-nonafluorobutane sulfonyl fluoride (17.3 mL) was added, and the temperature was gradually raised to room temperature, followed by stirring for 20 hours. Water (500 mL) was added, and the organic layer was washed with a saturated sodium chloride aqueous solution and dried, and then, the solvent was removed to obtain a crude product (44.5 g) of 2,2,3,3,4,4,5,5-octafluoro-6-(tetrahydro-2H-pyran-2-yloxy)hexyl-1,1,2,2,3,3,4,4,4-nonafluorobutane sulfonate.

This crude product (22.50 g) and compound (20) (10.43 g) were dissolved in N,N-dimethylformamide (400 mL), and cesium carbonate (36.26 g) was added, followed by stirring at 80° C. for one hour. Water (300 mL) was added, followed by extraction with t-butyl methyl ether (300 mL). The obtained organic layer was washed with a saturated sodium chloride aqueous solution (300 mL), and then, the solvent was removed to obtain a crude product of compound (35). This crude product was purified by column chromatography using hexane/ethyl acetate as a developing liquid, to obtain 18.48 g of compound (35). The yield was 86%.

### Preparation of Compound (36):

Into a 1 L four-necked flask equipped with a reflux device and a stirrer, compound (35) (18.48 g), methanol (300 mL), tetrahydrofuran (300 mL) and p-toluene sulfonic acid monohydrate (0.66 g) were added and stirred at room temperature for 30 minutes. Triethylamine (0.50 mL) was added, and the solvent was distilled off under reduced pressure to obtain a crude product. This crude product was purified by column chromatography using hexane/ethyl acetate as a developing liquid, to obtain 16.04 g of compound (36). The yield was 100%.

### Preparation of Monomer (3-4)

Into a 1 L four-necked flask equipped with a reflux device and a stirrer, compound (36) (16.04 g), dichloromethane (300 mL) and triethylamine (6.18 mL) were added, followed by cooling to 0° C. Acrylic acid chloride (3.61 mL) was added, and the temperature was gradually raised to room temperature, followed by stirring for 11 hours. The solvent was distilled off under reduced pressure, and the obtained crude product was purified by column chromatography using hexane/ethyl acetate as a developing liquid, to obtain 11.80 g of monomer (3-4). The yield was 67%.

### Spectrum Data of Monomer (3-4):

¹H-NMR (300.4 MHz, solvent: CDCl₃, standard: TMS) δ (ppm): 0.95 (t, 3H), 1.53-2.05 (m, 10H), 2.35 (s, 3H), 2.54-2.80 (m, 4H), 4.43 (t, 2H), 4.67 (t, 2H), 5.97 (dd, 1H), 6.18 (dd, 1H), 6.52 (dd, 1H), 6.77 (m, 2H), 7.11-7.21 (m, 5H)

¹⁹F-NMR (282.7 MHz, solvent: CDCl₃, standard: TMS) δ (ppm): −120.2 (m, 4F), −124.0 (m, 2F), −124.2 (m, 2F)

### Preparation Example 4

### Preparation Example of Liquid Crystal Polymer to be Used in Examples

Into a 10 mL screw stopper test tube, monomer (3-1) (0.563 g), monomer (3-2) (0.437 g), a polymerization initiator (product name “V40”, manufactured by Wako Pure Chemical Industries, Ltd., 0.01 g), a chain transfer agent 1-dodecanethiol (0.025 g) and toluene (1.25 g) were put, and after substitution with nitrogen, the test tube was closed. The screw stopper test tube was stirred and shaked for polymerization for 18 hours in a constant temperature tank at 80° C.

The polymerized content was stirred in methanol for 10 minutes, and then, the polymer was taken out. This operation was carried out three times. Then, the polymer was dissolved in tetrahydrofuran and dropwise added into methanol with stirring for reprecipitation. Further, the polymer was stirred in methanol for 10 minutes, and then, the polymer was taken out. This operation was carried out three times. The liquid crystalline polymer was again reprecipitated for purification and dried at 40° C. for two hours in a vacuum dryer to obtain a white liquid crystal polymer (p-1). The obtained amount was 0.90 g, and the yield was 90%.

### Preparation Examples 5 to 9

### Preparation Examples for Liquid Crystal Polymers

The polymerization and purification were carried out in the same manner as in the preparation of the liquid crystal polymer (p-1), except that blending of the starting materials was changed as shown in Table 1, to obtain liquid crystal polymers (p-2) to (p-6). In Table 1, “phr” represents the proportion of the chain transfer agent or the proportion of the initiator per 100 parts by mass of the monomers, and “M/S” represents the mass of the monomers/the mass of the solvent.

TABLE 1

| | | | | | | | Chain transfer | | |
|---|---|---|---|---|---|---|---|---|---|
| Prep. | Liquid crystal | Monomer (mol %) | | | | | agent | Initiator | Solvent |
| Ex. | polymer | (3-1) | (3-2) | (3-3) | (3-4) | (X) | phr | phr | M/S |
| 4 | (p-1) | 60 | 40 | — | | — | 2.5 | 1.0 | 0.8 |
| 5 | (p-2) | 45 | 45 | 10 | | — | 2.5 | 1.0 | 0.8 |
| 6 | (p-3) | 25 | 50 | 25 | | — | 2.5 | 1.0 | 0.8 |
| 7 | (p-4) | 40 | 60 | | | | 2.5 | 1.0 | 0.8 |
| 8 | (p-5) | | | 30 | 70 | | 2.5 | 1.0 | 0.8 |
| 9 | (p-6) | — | — | — | | 100 | 2.5 | 1.0 | 0.8 |

The number average molecular weights (Mn), glass transition temperatures (Tg), transition temperatures from smectic phase to nematic phase, and clearing points (Tc) of the obtained liquid crystal polymers (p-1) to (p-6) are shown in Table 2.

TABLE 2

| | | | | Transition temperature | |
|---|---|---|---|---|---|
| Prep. | Liquid crystal | | Tg | from Sm phase to N | Tc |
| Ex. | polymer | Mn | (° C.) | phase (° C.) | (° C.) |
| 4 | (p-1) | 15,100 | 4 | Nil | 139 |
| 5 | (p-2) | 13,100 | 7 | 80 | 160 |
| 6 | (p-3) | 13,600 | 8 | 195 | 210 |
| 7 | (p-4) | 12,800 | 5 | Sm not observed | 118 |
| 8 | (p-5) | 14,500 | 10 | Only Sm observed | 150 |
| 9 | (p-6) | 15,000 | 20 | Nil | 120 |

### Preparation Example 10

### Preparation Example for Covering Polymer

Into a 10 mL screw stopper test tube, monomer (1.0 g) represented by the following formula (1-1), and initiator V40 (0.01 g), a chain transfer agent 1-dodecanethiol (0.025 g) and DMF (1.25 g) were put, and after substitution with nitrogen, the test tube was closed. Such a mixture was stirred and polymerized at 80° C. for 18 hours. After the stirring, purification was carried out by methanol to obtain a covering polymer (q-1). The obtained amount was 0.90 g and the yield was 90%.

CH₂═CH—COO—(CH₂)₂—(CF₂)₆—F (1-1)

### Preparation Examples 11 to 14

### Preparation Examples for Covering Polymers

The polymerization and purification were carried out in the same manner as in the preparation for the covering polymer (q-1), except that blending of the starting materials was changed as shown in Table 3, to obtain covering polymers (q-2) to (q-5). In Table 3, “phr” represents the proportion of the chain transfer agent or the proportion of the initiator, per 100 parts by mass of the monomer, and “M/S” represents the mass of the monomer/the mass of the solvent. The monomers (1-2) to (1-5) are compounds represented by the following formulae (I-2) to (1-5).

CH₂═C(CH₃)—COO—(CH₂)₂—(CF₂)₆—F (1-2)

CH₂═CCl—COO—(CH₂)₂—(CF₂)₆—F (1-3)

CH₂═CH—COO—(CH₂)₂—(CF₂)₈—F (1-4)

CH₂═CH—COO—(CH₂)₃—CH₃ (1-5)

TABLE 3

| | | | | | | | Chain transfer | | |
|---|---|---|---|---|---|---|---|---|---|
| Prep. | Covering | Monomer (mol %) | | | | | agent | Initiator | Solvent |
| Ex. | polymer | (1-1) | (1-2) | (1-3) | (1-4) | (1-5) | phr | phr | M/S |
| 10 | (q-1) | 100 | — | — | — | — | 2.5 | 1.0 | 0.8 |
| 11 | (q-2) | — | 100 | — | — | — | 2.5 | 1.0 | 0.8 |
| 12 | (q-3) | — | — | 100 | — | — | 2.5 | 1.0 | 0.8 |
| 13 | (q-4) | — | — | — | 100 | — | 2.5 | 1.0 | 0.8 |
| 14 | (q-5) | — | — | — | — | 100 | 2.5 | 1.0 | 0.8 |

The number average molecular weights (Mn), glass transition temperatures (Tg) and melting points (Tm) of the obtained covering polymers (q-1) to (q-5) and a fluoropolymer “Cytop CTX-S grade” (q-6), tradename, manufactured by Asahi Glass Company, Limited, are shown in Table 4.

TABLE 4

| Prep. | Covering | | Tg | Tm |
|---|---|---|---|---|
| Ex. | polymer | Mn | (° C.) | (° C.) |
| 10 | (q-1) | 6,000 | −6 | — |
| 11 | (q-2) | 7,000 | 33 | — |
| 12 | (q-3) | 10,000 | 105 | — |
| 13 | (q-4) | 8,000 | — | 75 |
| 14 | (q-5) | 9,000 | 9 | — |
| | (q-6) | — | 108 | — |

### Example 1

### Preparation of Liquid Crystal Polymer Laminate

The liquid crystal polymer (p-1) (0.2 g) was dissolved in tetrahydrofuran (1.0 g). The obtained solution was applied by spin coating on an alignment film-coated glass substrate (20 mm×25 mm×0.7 mm) to form a thin film of the liquid crystal polymer solution. The substrate was dried at 50° C. for 10 minutes to remove the solvent thereby to form a liquid crystal polymer layer.

Then, the covering polymer (q-1) (0.1 g) was dissolved in dichloropentafluoropropane (1.0 g) as a solvent not to dissolve the liquid crystal polymer, and the obtained solution was coated by spin coating on the liquid crystal polymer layer prepared as described above. The solvent was removed by drying at 50° C. for 10 minutes. Thereafter, heat treatment was carried out at 130° C. for 10 minutes, followed by gradual cooling to room temperature to obtain a liquid crystal polymer laminate 1. The thickness of the liquid crystal polymer layer in the liquid crystal polymer laminate was 3.1 μm, and the thickness of the covering polymer layer was 0.8 μm.

With respect to the obtained liquid crystal polymer laminate (hereinafter referred to as the laminate A), the in-plane irregularity, the aligned state and the haze were measured. The results of the measurements are shown in Table 5.

### Examples 2 to 17

In the same manner as in Example 1 except that the liquid crystal polymer, the covering polymer and the heat treatment temperature were changed as shown in Table 5, liquid crystal polymer laminates similar to the laminate A were obtained. The liquid crystal polymer laminates in Examples 2 to 12 will be referred to as laminates B to L, respectively. Here, Example 2′ is an example wherein the same laminate as in Example 2 was prepared except that the solvent to dissolve the covering polymer (q-1) was changed from dichloropentafluoropropane to 1,3-bis(trifluoromethyl)benzene (the obtained laminate will be referred to as laminate B′). Examples 10 and 11 are Examples wherein laminates J and K were prepared in the same manner as in Example 1 by using “Cytop CTX-809SP2”, tradename, manufactured by Asahi Glass Company, Limited employing “CT-Solv. 180” tradename, manufactured by Asahi Glass Company, Limited as the solvent to dissolve the covering polymer (q-6).

In the same manner as in Example 1 except that the liquid crystal polymer and the heat treatment temperature were changed as shown in Table 5, and the covering polymer was not laminated, comparative samples 1 to 5 (Examples 13 to 17) were obtained.

TABLE 5

| | Liquid crystal | | | Heat treatment | | | |
|---|---|---|---|---|---|---|---|
| | polymer | Liquid crystal | Covering | temperature | In-plane | Aligned | Haze |
| Ex. | laminate | polymer | polymer | (° C.) | irregularity | state | (%) |
| 1 | Laminate A | (p-1) | (q-1) | 130 | Nil | Horizontal | 0.4 |
| 2 | Laminate B | (p-2) | (q-1) | 150 | Nil | Horizontal | 0.6 |
| 2′ | Laminate B′ | (p-2) | (q-1) | 150 | Nil | Horizontal | 0.5 |
| 3 | Laminate C | (p-3) | (q-1) | 200 | Nil | Hybrid | 0.2 |
| 4 | Laminate D | (p-2) | (q-2) | 150 | Nil | Horizontal | 0.8 |
| 5 | Laminate E | (p-2) | (q-3) | 150 | Nil | Horizontal | 0.2 |
| 6 | Laminate F | (p-6) | (q-1) | 80 | Nil | Horizontal | 0.6 |
| 7 | Laminate G | (p-2) | (q-4) | 150 | Slightly | Horizontal | 2.0 |
| | | | | | observed | | |
| 8 | Laminate H | (p-2) | (q-3) | 90 | Present | Hybrid | 3.5 |
| 9 | Laminate I | (p-2) | (q-5) | 150 | Nil | Horizontal | 0.4 |
| 10 | Laminate J | (p-2) | (q-6) | 150 | Nil | Horizontal | 0.4 |
| 11 | Laminate K | (p-5) | (q-6) | 90 | Present | Horizontal | 3.7 |
| 12 | Laminate L | (p-4) | (q-2) | 130 | Nil | Horizontal | 0.9 |
| 13 | Comparative | (p-1) | — | 130 | Present | Hybrid | 5.0 |
| | sample 1 | | | | | | |
| 14 | Comparative | (p-2) | — | 150 | Present | Hybrid | 11.7 |
| | sample 2 | | | | | | |
| 15 | Comparative | (p-3) | — | 200 | Present | Hybrid | 10.6 |
| | sample 3 | | | | | | |
| 16 | Comparative | (p-4) | — | 90 | Present | Hybrid | 2.5 |
| | sample 4 | | | | | | |
| 17 | Comparative | (p-5) | — | 130 | Present | Hybrid | 4.2 |
| | sample 5 | | | | | | |

In Table 5, “Horizontal alignment” is one wherein liquid crystal molecules are horizontally aligned at both surfaces of the liquid polymer layer. “Hybrid alignment” means that on the aligned film-coated glass substrate side, the liquid crystal polymer layer shows horizontal alignment, but on the opposite side, it shows vertical alignment or alignment in a state risen towards vertical alignment. In Examples 1 to 7, 9, 10 and 12 (with laminates A to F, I, J and L), it was confirmed that the transparency was excellent, there was no in-plane irregularity, and the liquid crystal alignment was three-dimensionally controlled. Further, in Example 7 (laminate G: crystalline covering polymer was used), the in-plane irregularity was slightly observed and the haze increased, but the transparency was fairly good. Further, in Example 3, alignment was hybrid alignment, but there was substantially no reverse tilt, and the haze was low.

In Examples 8 and 11 being Comparative Examples (laminates H and K: the heat treatment temperature being lower than the glass transition point of the covering polymer), the in-plane irregularity was substantial, and the haze became high. Here, the liquid crystal polymer (p-4) is a liquid crystal polymer having no durability against blue laser. Further, in each of Examples 13 to 17 being Comparative Examples in which no covering polymer layer was laminated, alignment was hybrid alignment and reverse tilt was frequented wherein the partially rising direction of liquid crystal was reversed, and the in-plane irregularity increased, and the haze was high.

### Example 18

The liquid crystal polymer (p-2) (0.2 g) was dissolved in tetrahydrofuran (1.0 g). The obtained solution was applied by spin coating on an alignment film-coated glass substrate (20 mm×25 mm×0.7 mm) to form a thin film of the liquid crystal polymer solution. The substrate was dried at 50° C. for 10 minutes to remove the solvent thereby to form a liquid crystal polymer layer.

Then, using a liquid curable dimethylene silicone (“silicone elastomer curing agent: SYLGARD184”, tradename, manufactured by Dow Corning; hereinafter referred to as the curable silicone R), a covering layer made of the silicone elastomer was formed on the liquid crystal polymer layer surface. This liquid curable silicone R is a liquid curable resin having room temperature curability (curable also by heat curing) not to dissolve the liquid crystal polymer, and the glass transition temperature (Tg) of the silicone elastomer as its cured product is at most 0° C. The cured product of such a curable resin will hereinafter be referred to as a covering polymer (q-7).

On the layer of the above liquid crystal polymer (p-2), the above liquid curable silicone R containing no solvent was applied by spin coating. Then, heat treatment was carried out at 150° C. for 10 minutes to carry out curing of the curable silicone R and alignment of the liquid crystal layer simultaneously. Thereafter, the temperature was gradually lowered to room temperature to obtain a liquid crystal polymer laminate having a thickness of the liquid crystal polymer layer being 3.0 μm and a thickness of the covering polymer layer being 40 μm. With respect to the obtained liquid crystal polymer laminate (hereinafter referred to as laminate M), the in-plane irregularity, aligned state and haze were measured. The results of the measurements are shown in Table 6. Further, since the covering polymer layer was thick, it was possible to peel the covering polymer layer from the liquid crystal polymer layer. The liquid crystal polymer layer after peeling the covering polymer layer, maintained the aligned state.

### Example 19

In Example 18, curing of the curable silicone R formed on the layer of the liquid crystal polymer (p-2) was carried out at room temperature for 48 hours, followed by heat treatment. The heat treatment and subsequent operation were carried out in the same manner as in Example 18 to obtain a liquid crystal polymer laminate (hereinafter referred to as laminate N) similar to the laminate M (thickness of the covering polymer layer: 40 μm).

### Example 20

In Example 18, using the curable silicone R (0.1 g) dissolved in dichloropentafluoropropane (1.0 g), as a coating liquid, this coating liquid was applied by spin coating on a layer of the liquid crystal polymer (p-2), and then, the solvent was removed at 50° C. for 10 minutes. Otherwise, in the same manner as in Example 18, a liquid crystal polymer laminate (hereinafter referred to as laminate 0) was obtained which was similar to the laminate M (provided that the thickness of the covering polymer layer was 1.5 μm).

### Example 21

In Example 18, using the curable silicone R (0.1 g) dissolved in dichloropentafluoropropane (1.0 g), as a coating liquid, this coating liquid was applied by spin coating on a layer of the liquid crystal polymer (p-2), and then, the solvent was removed at 50° C. for 10 minutes. Then, curing of the curable silicone R formed on the layer of the liquid crystal polymer (p-2) was carried out at room temperature for 48 hours, followed by heat treatment. The heat treatment and subsequent operation were carried out in the same manner as in Example 18, to obtain a liquid crystal polymer laminate (hereinafter referred to as laminate P) similar to the laminate M (provided that the thickness of the covering polymer layer was 1.5 μm).

With respect to the laminates M to P, the in-plane irregularity, aligned state and haze were measured. The results of measurements are shown in Table 6.

TABLE 6

| | Liquid crystal | | | Heat treatment | | | |
|---|---|---|---|---|---|---|---|
| | polymer | Liquid crystal | Covering | temperature | In-plane | Aligned | Haze |
| Ex. | laminate | polymer | polymer | (° C.) | irregularity | state | (%) |
| 18 | Laminate M | (p-2) | (q-7) | 150 | Nil | Horizontal | 0.9 |
| 19 | Laminate N | (p-2) | (q-7) | 150 | Nil | Horizontal | 0.9 |
| 20 | Laminate O | (p-2) | (q-7) | 150 | Nil | Horizontal | 0.3 |
| 21 | Laminate P | (p-2) | (q-7) | 150 | Nil | Horizontal | 0.4 |

### INDUSTRIAL APPLICABILITY

The liquid crystal polymer laminate obtained by the present invention can be used for various retardation plates, such as a positive A plate, a negative A plate, a positive C plate, a negative C plate, a twist retardation film, a viewing angle enlarging film, a temperature-compensation film, a quarter-wave plate and a half-wave plate.

The entire disclosure of Japanese Patent Application No. 2007-226311 filed on Aug. 31, 2007 including specification, claims and summary is incorporated herein by reference in its entirety.

What is claimed is:

1. A process for producing a liquid crystal polymer laminate comprising a substrate, a layer containing a liquid crystal polymer, and a layer containing a non-liquid crystal covering polymer, which comprises a step of forming the layer containing a liquid crystal polymer on the substrate surface, a step of forming the layer containing the covering polymer on the layer containing a liquid crystal polymer, and a step of performing heat treatment at a temperature of at least the glass transition point or the melting point of the covering polymer and at most the clearing point of the liquid crystal polymer.

2. The process according to claim 1, wherein the substrate surface is a surface with aligning treatments.

3. The process according to claim 1, wherein the step of forming the layer containing the covering polymer on the layer containing a liquid crystal polymer is a step of applying a liquid containing the covering polymer and a solvent which does not substantially dissolve the liquid crystal polymer, on the layer containing the liquid crystal polymer, and removing the solvent to form the layer containing the covering polymer.

4. The process according to claim 3, wherein the solvent which does not substantially dissolve the liquid crystal polymer is a fluorinated solvent.

5. The process according to claim 1, wherein the covering polymer is a non-crystalline polymer.

6. The process according to claim 1, wherein the covering polymer is a fluoropolymer.

7. The process according to claim 6, wherein the fluoropolymer is a polymer containing monomer units derived from a monomer represented by the following formula (1):
CH₂═CX—COO—(CH₂)₂—(CF₂)ₚ—F (1)
wherein the symbols are as follows:
X: a hydrogen atom, a chlorine atom or a methyl group,
p: 4, 5 or 6.

8. The process according to claim 1, wherein the covering polymer is a silicone polymer.

9. The process according to claim 1, wherein the liquid crystal polymer is a polymer containing monomer units derived from a monomer represented by the following formula (3):
CH₂═CR¹—COO—[(CH₂)ₘ—(CF₂)ᵣ—(CH₂)ₙ—O]ₜ-E¹-(G¹)ᵥ-(E²)ₕ-(G²)_{w}-(E³)ₖ-E⁴-R³ (3)
wherein the symbols are as follows:
R¹: a hydrogen atom or a methyl group,
R³: a C₁₋₈ alkyl group which may be fluorinated, a C₁₋₈ alkoxy group which may be fluorinated, or a fluorine atom,
E¹, E², E³, E⁴: each independently a 1,4-phenylene group or a trans-1,4-cyclohexylene group, provided that a hydrogen atom bonded to a carbon atom in such a group may be substituted by a
C₁₋₁₀ alkyl group, a C₁₋₁₀ alkoxy group or a fluorine atom,
G¹, G²: each independently —COO— or —OCO— (provided that the carbon atom in such an oxycarbonyl group is not bonded to the 1,4-phenylene group),
m: an integer of from 0 to 6,
r: an integer of from 0 to 6,
n: an integer of from 0 to 6,
provided that m+r+n is an integer of at least 1, and when r is 0, m+n is an integer of at most 10,
t: 0 or 1,
h: 0 or 1,
k: 0 or 1,
v: 0 or 1,
w: 0 or 1,
provided that v+w is 0 or 1.

10. The process according to claim 1, wherein the aligned state of the liquid crystal polymer is a horizontal alignment to the substrate surface.

11. A liquid crystal polymer laminate comprising a layer of a liquid crystal polymer formed on an aligned substrate surface, and a layer of a covering polymer formed on the layer of a liquid crystal polymer, wherein the liquid crystal polymer is formed as aligned at a temperature of at least the glass transition point or the melting point of the covering polymer and at most the clearing point of the liquid crystal polymer in such a state that the layer containing the liquid crystal polymer is present on the substrate surface.

12. The liquid crystal polymer laminate according to claim 11, wherein the layer containing the covering polymer is a layer formed by applying a liquid containing the covering polymer and a solvent which does not substantially dissolve the liquid crystal polymer, on the layer containing the liquid crystal polymer, and removing the solvent.
